(19) United States
(12) Patent Application Publication
(10) Pub. No.: US 2025/0279865 A1
(43) Pub. Date: Sep. 4, 2025

(54) REFERENCE SIGNAL CONFIGURATION FOR SUBBAND FULL DUPLEX OPERATION

(71) Applicant: Telefonaktiebolaget LM Ericsson (publ), Stockholm (SE)

(72) Inventors: Stephen GRANT, Pleasanton, CA (US); Jung-Fu CHENG, Fremont, CA (US); Yuhang LIU, Lund (SE)

(21) Appl. No.: 18/858,908

(22) PCT Filed: Apr. 28, 2023
(86) PCT No.: PCT/EP2023/061408

§ 371 Date: Oct. 22, 2024

Related U.S. Application Data
(60) Provisional application No. 63/336,130, filed on Apr. 28, 2022.

(51) Int. Cl. H04L 5/00; H04L 5/14

(52) U.S. Cl. CPC H04L 5/0051; H04L 5/14

(57) ABSTRACT

A method, system and apparatus are disclosed. According to some embodiments, a network node configured to communicate with a wireless device (WD) is provided. The network node is configured to configure a WD with a resource block (RB) configuration, the RB configuration including one of: a first set of at least one uplink RB separating two sets of at least one downlink RB in the frequency domain, the two sets of at least one downlink RB being configured as a channel state information reference signal (CSI-RS) resource; and a second set of at least one downlink RB separating two sets of at least one uplink RB, the two sets of at least one uplink RB being configured as a sounding reference signal (SRS) resource.

### TECHNICAL FIELD

The present disclosure relates to wireless communications, and in particular, to frequency domain resource allocation (FDRA) such as non-contiguous FDRA.

### BACKGROUND

New radio (NR) standard in 3GPP is being designed to provide service for multiple use cases such as enhanced mobile broadband (eMBB), ultra-reliable and low latency communication (URLLC), and machine type communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot may consist of any number of 1 to 14 orthogonal frequency division multiplexed (OFDM) symbols. It should be noted that the concepts of slot and mini-slot are not specific to a specific service meaning that a mini-slot may be used for either eMBB, URLLC, or other services. FIG. 1 is an example radio resource diagram in NR.

In 3GPP Technical Release 15 (3GPP Rel-15), a wireless device (WD) may be configured with up to four carrier bandwidth parts in the downlink with a single downlink carrier bandwidth part being active at a given time. A wireless device may be configured with up to four carrier bandwidth parts in the uplink with a single uplink carrier bandwidth part being active at a given time.

An NR slot includes either 7 or 14 symbols (OFDM subcarrier spacing≤60 kHz) and 14 symbols (OFDM subcarrier spacing >60 kHz). FIG. 2 is a diagram of a subframe with 14 OFDM symbols. In the example of FIG. 2, T_ₛ and T__{symb} denote the slot and OFDM symbol duration, respectively.

### FDD and TDD Systems

1 Transmission and reception from a node, e.g., a terminal in a cellular system, may be multiplexed in the frequency domain or in the time domain (or combinations thereof). Frequency Division Duplex (FDD), as illustrated in the example of FIG. 3, implies that downlink and uplink transmission takes place in different, sufficiently separated, frequency bands. Time Division Duplex (TDD), as illustrated in the example diagram of FIG. 4, implies that downlink and uplink transmission take place in different, non-overlapping time slots. Thus, TDD may operate in unpaired spectrum, whereas FDD requires paired spectrum. FIG. 5 is a diagram of an example of a half-duplex FDD configuration.

Typically, the structure of the transmitted signal in a communication system is organized in the form of a frame structure. For example, NR uses ten equally-sized slots per radio frame, as illustrated in the example of FIG. 6 for the case of 15 kHz subcarrier spacing.

In the case of FDD operation (upper part of FIG. 6), there are two carrier frequencies, one for uplink transmission (f_{UL}) and one for downlink transmission (f_{DL}). At least with respect to the terminal in a cellular communication system, FDD may be either full duplex or half duplex. In the full duplex case, a terminal may transmit and receive simultaneously, while in half-duplex operation, the terminal cannot transmit and receive simultaneously (the base station is capable of simultaneous reception/transmission though, e.g., receiving from one terminal while simultaneously transmitting to another terminal). In LTE, a half-duplex terminal is configured to monitor and receive in the downlink except when explicitly being instructed to transmit in a certain subframe.

In case of TDD operation (lower part of FIG. 6), there is only a single carrier frequency and uplink and downlink transmissions that are always separated in time on a cell-by-cell basis. As the same carrier frequency is used for uplink and downlink transmission, both the base station and the mobile terminals need to switch from transmission to reception and vice versa. One aspect of any TDD system is to provide the possibility for a sufficiently large guard time where neither downlink nor uplink transmissions occur. This may be required to avoid interference between uplink and downlink transmissions. For NR, this guard time is provided by special subframes, which are split into three parts: symbols for DL, a guard period (GP), and symbols for uplink. The remaining subframes are either allocated to uplink or downlink transmission.

In particular, the following two information elements (IEs) are defined in existing 3GPP specifications. The TDD pattern is typically configured with at least the first IE and optionally the 2nd IE:
TDD-DL-UL-ConfigCommon (cell-specific); and
TDD-DL-UL-ConfigDedicated (WD-specific)

The first IE is cell specific (common to all wireless devices (e.g., WDs)) and is provided by broadcast signaling. The first IE provides the number of slots in the TDD pattern via a reference subcarrier spacing and a periodicity such that the S-slot pattern repeats every S slots. This IE allows for very flexible configuration of the pattern characterized as follows:
A number of full downlink slots at the beginning of the pattern configured by the parameter nDownlinkSlots;
A number of full uplink slots at the end of the pattern configured by the parameter nUplinkSlots;
A number of downlink (‘D’) symbols following the full downlink slots configured by the parameter nDownlinkSymbols;
A number of uplink (‘U’) symbols preceding the full downlink slots configured by the parameter nUplinkSlots;
If there is a gap between the last downlink symbol and the first uplink symbol, then all symbols in the gap are characterized as flexible (‘F’). A symbol classified as ‘F’ may be used for downlink or uplink. A WD determines the direction in one of the following two ways:
   Detecting a DCI that schedules/triggers a DL signal/channel, e.g., physical downlink shared channel (PDSCH), channel state information reference signal (CSI-RS) or schedules/triggers an UL signal/channel, e.g., physical uplink shared channel (PUSCH), sounding reference signal (SRS), etc.;
   By dedicated (WD-specific) signaling of the IE TDD-DL-UL-ConfigDedicated. This parameter overrides some or all of the ‘F’ symbols in the pattern, thus providing a semi-static indication of whether a symbol is classified as ‘D’ or ‘U’; and/or
Optionally, a 2^{nd} pattern that is concatenated to the first pattern may be configured as above. If a 2^{nd} pattern is configured, the constraint is that the sum of the periodicities of the two patterns must evenly divide 20 ms.

FIG. 7 is a diagram that shows an example TDD DL/UL pattern configured by TDD-DL-UL-ConfigCommon. This TDD DL/UL pattern includes 3 full ‘D’ slots, 1 full ‘U’ slot, with a mixed slot in between consisting of 4 ‘D’ symbols and 3 ‘U’ symbols. The remaining 7 symbols in the mixed slot are classified as ‘F.’
2 If a wireless device is not configured with TDD-DL-UL-ConfigDedicated, then the pattern at the top of the diagram is what the wireless device assumes. As stated above, the network may make use of the ‘F’ symbols flexibly, by scheduling and triggering either an uplink or a downlink signal or channel in a wireless device-specific manner. This allows for very dynamic behavior: the direction is not known to the wireless device a priori; rather, the direction becomes known once the wireless device detects a downlink control information (DCI) message that schedules or triggers a particular DL or UL signal/channel.

In contrast, the DL/UL direction for some or all of the ‘F’ symbols in a particular slot may be provided to the wireless device in a semi-static manner by radio resource control (RRC) signaling to configure the wireless device with TDD-DL-UL-ConfigDedicated. The lower part of the example diagram of FIG. 7 illustrates 3 example configurations for overriding ‘F’ symbols in Slot 3. In particular, the example in FIG. 7 has S=5 slots. If the IE indicates ‘allDownlink’ or ‘allUplink’ for a particular slot (or slots), then all ‘F’ symbols in the slot are converted to either ‘D’ or ‘U,’ respectively. If the IE indicates ‘explicit,’ then a number of symbols at the beginning of the slot and/or a number of symbols at the end of the slot are indicated as ‘D’ and ‘U,’ respectively. In the example of FIG. 8, in the explicit configuration, the first 7 and the last 5 are indicated as ‘D’ and ‘U’, which converts some of the ‘F’ symbols (but not all in this example) to ‘D’ and ‘U.’

One behavior in the above is that the WD-specific IE TDD-DL-UL-ConfigDedicated may only override (i.e., specify ‘D’ or ‘U’) for symbols that are configured as ‘F’ by the cell-specific IE TDD-DL-UL-ConfigCommon. In other words, a wireless device does not expect to have a ‘D’ symbol converted to ‘U’ or vice versa.

FIG. 8 is a diagram of three additional example TDD DL/UL patterns configured by TDD-DL-UL-ConfigCommon. In the first and second patterns, there are no ‘F’ symbols, hence according to existing behavior in the 3GPP Rel-17 (Rel-17) specifications, the wireless device would not expect to be configured with TDD-DL-UL-ConfigDedicated. In the second pattern, all symbols in Slots 1, 2, and 3 are configured as ‘F;’ hence, the wireless device may be configured with TDD-DL-UL-ConfigDedicated to provide a direction (‘D’ or ‘U’) for any or all symbols in these 3 slots. Note that the existing 3GPP Rel-17 specifications allow the dedicated configuration of the TDD pattern on a slot-specific basis. In other words, TDD-DL-UL-ConfigDedicated is not restricted to be the same in each slot where ‘F’ symbols are overridden.

### Subband Full Duplex

As described above, in a conventional TDD system, the entire carrier bandwidth (BW) or all carriers in the same frequency band may need to utilize the same DL transmission or UL reception directions. This is further illustrated in the example of FIG. 9.

For the 3GPP Rel-18 evolution of the NR system, 3GPP has decided to study the technical feasibilities and potential benefits of subband full duplex (SBFD) systems:
In such a system, a portion of a wide bandwidth carrier may be used for a different direction than that of the rest of the carrier. This is illustrated in the left-hand side of the example diagram of FIG. 10. That is, unlike a conventional TDD system as shown on the left-hand side of the example diagram of FIG. 9 where the entire bandwidth is used for DL transmission in the first three slots, the center portion of the SBFD carrier is used for UL reception while the rest of the carrier continues to be used for DL transmission as shown in the left-hand side of FIG. 10; and
Similarly, instead of utilizing all carriers for the same DL or UL directions in a conventional TDD system as shown in the right-hand side of FIG. 9, some carriers in the SBFD system may be used for a different direction than that of the other carriers as shown in the right-hand side of FIG. 10.

In the 3GPP Rel-18 study, the scope has been limited such that in SBFD operation, only network nodes (e.g., gNBs) transmit DL and receive UL simultaneously. An individual wireless device is scheduled in only one direction (DL or UL) at a time.

### Advanced Antenna Arrays for TDD Systems

Modern cellular wireless communication systems utilize advance antenna array systems to perform beamforming and MIMO transmission in order to enhance the coverage and throughput of the system. A generic example antenna array for a TDD system is illustrated in the example of FIG. 11. In such an example array, multiple antenna elements are utilized and typically placed in a planar array with horizontal and vertical spacings suitable for the operating frequency bands. For a TDD network node (e.g., base station), the antenna array is connected to a transmit/receive (TX/RX) switch such that the same antenna array may be used for transmitting DL signals in a DL slot as well as used for receiving UL signals in a UL slot,

### Antenna Architecture I for SBFD Systems

In an SBFD system, the network node may need to perform DL transmission and UL reception simultaneously. It hence may become necessary to utilize two antenna arrays for the two directions, respectively as illustrated in FIG. 12 where:
A first antenna array is utilized for UL reception only; and
A second antenna array is utilized for DL transmission only.

It also may be necessary to introduce additional isolation material or mechanisms between the two antenna arrays to suppress the signal leaking from the TX array into the RX array. Without such isolation, the UL receiver may be de-sensitized due to the fact that the DL transmit power is generally much higher than the UL receive power.

### CSI-RS Configuration

In existing 3GPP Rel-17 specifications, a wireless device may be configured with multiple CSI-RS resources, and each CSI-RS resource is configured according to 3GPP Technical Standard (TS) 38.331 as follows:

```
NZP-CSI-RS-Resource ::= SEQUENCE {
  nzp-CSI-RS-ResourceId NZP-CSI-RS-ResourceId,
  resourceMapping CSI-RS-ResourceMapping,
  powerControlOffset INTEGER (−8..15),
  powerControlOffsetSS ENUMERATED{db-3, db0, db3, db6}
OPTIONAL, -- Need R
  scramblingID ScramblingId,
  periodicityAndOffset CSI-ResourcePeriodicityAndOffset OPTIONAL,
-- Cond PeriodicOrSemiPersistent
  qcl-InfoPeriodicCSI-RS TCI-StateId OPTIONAL, -- Cond
Periodic
  ...
```

The configuration includes an integer valued ID NZP-CSI-RS-ResourceId as follows:

NZP-CSI-RS-ResourceId::=INTEGER(0 . . . maxNrofNZP-CSI-RS-Resources−1)

where the maximum number of CSI-RS resources is 192. Hence the ID of a CSI-RS resource may be any value between 0 and 191.

The frequency domain resource allocation of a CSI-RS is defined by CSI-RS-ResourceMapping as follows:

```
CSI-RS-ResourceMapping ::= SEQUENCE {
  frequencyDomainAllocation CHOICE {
    row1 BIT STRING (SIZE (4)),
    row2 BIT STRING (SIZE (12)),
    row4 BIT STRING (SIZE (3)),
    other BIT STRING (SIZE (6))
  },
    nrofPorts ENUMERATED {p1,p2,p4,p8,p12,p16,p24,p32},
    firstOFDMSymbolInTimeDomain INTEGER (0..13),
    firstOFDMSymbolInTimeDomain2 INTEGER (2..12)
  OPTIONAL, -- Need R
    cdm-Type ENUMERATED {noCDM, fd-CDM2, cdm4-FD2-TD2,
  cdm8-FD2-TD4},
    density CHOICE {
      dot5 ENUMERATED {evenPRBs, oddPRBs},
      one NULL,
      three NULL,
      spare NULL
    },
    freqBand CSI-FrequencyOccupation,
    ...
  }
```

The frequency domain resource allocation (FDRA) is defined by CSI-FrequencyOccupation as follows:

```
CSI-FrequencyOccupation ::= SEQUENCE
  startingRB INTEGER (0..maxNrofPhysicalResourceBlocks-1),
  nrofRBs INTEGER (24..maxNrofPhysicalResourceBlocksPlus1),
  ...
}
```

One observation is that CSI-RS resources are restricted to occupy a contiguous set of RBs in the frequency domain, and this frequency domain occupation is defined by a starting RB and a number of RBs that may be as small as 24 and as large as 276.

CSI-RS resources are used for multiple purposes in NR, e.g., CSI reporting, beam management, quasi-colocation (QCL) sources for time and frequency tracking and adjustment of receive beams, etc. In many cases, multiple CSI-RS resources are configured as part of a CSI-RS resource set, and measurements are performed based on the resources in the set. A set is constructed by providing a list of CSI-RS resource IDs (illustrated below in bold):

```
NZP-CSI-RS-ResourceSet ::= SEQUENCE
  nzp-CSI-ResourceSetId NZP-CSI-RS-ResourceSetId,
  nzp-CSI-RS-Resources SEQUENCE (SIZE (1..maxNrofNZP-CSI-RS-
ResourcesPerSet)) OF NZP-CSI-RS-ResourceId,
  repetition ENUMERATED { on, off } OPTIONAL, --
Need S
  aperiodicTriggeringOffset INTEGER(0..6)
OPTIONAL, -- Need S
  trs-Info ENUMERATED {true}
OPTIONAL, -- Need R
  ...,
  [[
  aperiodicTriggeringOffset-r16 INTEGER(0..31) OPTIONAL --
Need S
  ]]
}
```

Another example of when CSI-RS resource IDs are used is for configuration of transmission configuration indicator (TCI) states which provide the quasi co-location (QCL) sources, e.g., a CSI-RS resource, used for aiding the reception of other signals, e.g., PDSCH, physical downlink control channel (PDCCH). This is illustrated in the bold text below.

```
TCI-State ::= SEQUENCE {
  tci-StateId TCI-StateId,
  qcl-Type1 QCL-Info,
  qcl-Type2 QCL-Info OPTIONAL, -- Need R
  ...
}
QCL-Info ::= SEQUENCE {
  cell ServCellIndex OPTIONAL, -- Need R
  bwp-Id BWP-Id OPTIONAL, -- Cond CSI-RS-
Indicated
  referenceSignal CHOICE {
    csi-rs NZP-CSI-RS-ResourceId,
    ssb SSB-Index
  },
  qcl-Type ENUMERATED {typeA, typeB, typeC, typeD)},
  ...
}
```

### SRS Configuration

In existing 3GPP Rel-17 specifications, a wireless device may be configured with multiple SRS resources, and each SRS resource is configured according to 3GPP 38.331 as follows:

```
SRS-Resource ::= SEQUENCE {
  srs-ResourceId SRS-ResourceId,
  nrofSRS-Ports ENUMERATED {port1, ports2, ports4},
  ptrs-PortIndex ENUMERATED {n0, n1 } OPTIONAL, --
Need R
  transmissionComb CHOICE {
    n2 SEQUENCE {
      combOffset-n2 INTEGER (0..1),
      cyclicShift-n2 INTEGER (0..7)
    },
    n4 SEQUENCE {
      combOffset-n4 INTEGER (0..3),
      cyclicShift-n4 INTEGER (0..11)
    }
  },
  resourceMapping SEQUENCE {
    startPosition INTEGER (0..5),
    nrofSymbols ENUMERATED {n1, n2, n4},
    repetitionFactor ENUMERATED {n1, n2, n4}
  },
  freqDomainPosition INTEGER (0..67),
  freqDomainShift INTEGER (0..268),
  freqHopping SEQUENCE {
    c-SRS INTEGER (0..63),
    b-SRS INTEGER (0..3),
    b-hop INTEGER (0..3)
  },
  groupOrSequenceHopping ENUMERATED { neither, groupHopping,
sequenceHopping },
  resourceType CHOICE {
    aperiodic SEQUENCE {
      ...
    },
    semi-persistent SEQUENCE {
      periodicityAndOffset-sp SRS-PeriodicityAndOffset,
      ...
    },
    periodic SEQUENCE {
      periodicityAndOffset-p SRS-PeriodicityAndOffset,
      ...
    }
  },
  sequenceId INTEGER (0..1023),
  spatialRelationInfo SRS-SpatialRelationInfo OPTIONAL, --
Need R
  ...,
  [[
  resourceMapping-r16 SEQUENCE {
    startPosition-r16 INTEGER (0..13),
    nrofSymbols-r16 ENUMERATED {n1, n2, n4},
    repetitionFactor-r16 ENUMERATED {n1, n2, n4}
  } OPTIONAL -- Need R
  ]]
}
```

The configuration includes an integer valued ID SRS-ResourceId as follows:

SRS-ResourceId::=INTEGER(0 . . . maxNrofSRS−Resources-1)

where the maximum number of SRS resources is 64. Hence the ID of an SRS resource may be any value between 0 and 63.

The frequency domain resource allocation of an SRS is defined by the following 5 parameters:

```
freqDomainPosition INTEGER (0..67),
freqDomainShift INTEGER (0..268),
freqHopping SEQUENCE
  c-SRS INTEGER (0..63),
  b-SRS INTEGER (0..3),
  b-hop INTEGER (0..3)},
```

The parameter c-SRS selects a row (e.g., illustrated in bold) from the following Table 1 (e.g., Table 6.4.1.4.3-1:) defined in 3GPP TS 38.211:

TABLE 1
(e.g., Table 6.4.1.4.3-1): SRS bandwidth configuration.

| | B_{SRS} = 0 | | B_{SRS} = 1 | | B_{SRS} = 2 | | B_{SRS} = 3 | |
|---|---|---|---|---|---|---|---|---|
| C_{SRS} | m_{SRS, 0} | N₀ | m_{SRS, 1} | N₁ | m_{SRS, 2} | N₂ | m_{SRS, 3} | N₃ |
| 0 | 4 | 1 | 4 | 1 | 4 | 1 | 4 | 1 |
| 1 | 8 | 1 | 4 | 2 | 4 | 1 | 4 | 1 |
| 2 | 12 | 1 | 4 | 3 | 4 | 1 | 4 | 1 |
| 3 | 16 | 1 | 4 | 4 | 4 | 1 | 4 | 1 |
| 4 | 16 | 1 | 8 | 2 | 4 | 2 | 4 | 1 |
| 5 | 20 | 1 | 4 | 5 | 4 | 1 | 4 | 1 |
| 6 | 24 | 1 | 4 | 6 | 4 | 1 | 4 | 1 |
| 7 | 24 | 1 | 12 | 2 | 4 | 3 | 4 | 1 |
| 8 | 28 | 1 | 4 | 7 | 4 | 1 | 4 | 1 |
| 9 | 32 | 1 | 16 | 2 | 8 | 2 | 4 | 2 |
| 10 | 36 | 1 | 12 | 3 | 4 | 3 | 4 | 1 |
| 11 | 40 | 1 | 20 | 2 | 4 | 5 | 4 | 1 |
| 12 | 48 | 1 | 16 | 3 | 8 | 2 | 4 | 2 |
| 13 | 48 | 1 | 24 | 2 | 12 | 2 | 4 | 3 |
| 14 | 52 | 1 | 4 | 13 | 4 | 1 | 4 | 1 |
| 15 | 56 | 1 | 28 | 2 | 4 | 7 | 4 | 1 |
| 16 | 60 | 1 | 20 | 3 | 4 | 5 | 4 | 1 |
| 17 | 64 | 1 | 32 | 2 | 16 | 2 | 4 | 4 |
| 18 | 72 | 1 | 24 | 3 | 12 | 2 | 4 | 3 |
| 19 | 72 | 1 | 36 | 2 | 12 | 3 | 4 | 3 |
| 20 | 76 | 1 | 4 | 19 | 4 | 1 | 4 | 1 |
| 21 | 80 | 1 | 40 | 2 | 20 | 2 | 4 | 5 |
| 22 | 88 | 1 | 44 | 2 | 4 | 11 | 4 | 1 |
| 23 | 96 | 1 | 32 | 3 | 16 | 2 | 4 | 4 |
| 24 | 96 | 1 | 48 | 2 | 24 | 2 | 4 | 6 |
| 25 | 104 | 1 | 52 | 2 | 4 | 13 | 4 | 1 |
| 26 | 112 | 1 | 56 | 2 | 28 | 2 | 4 | 7 |
| 27 | 120 | 1 | 60 | 2 | 20 | 3 | 4 | 5 |
| 28 | 120 | 1 | 40 | 3 | 8 | 5 | 4 | 2 |
| 29 | 120 | 1 | 24 | 5 | 12 | 2 | 4 | 3 |
| 30 | 128 | 1 | 64 | 2 | 32 | 2 | 4 | 8 |
| 31 | 128 | 1 | 64 | 2 | 16 | 4 | 4 | 4 |
| 32 | 128 | 1 | 16 | 8 | 8 | 2 | 4 | 2 |
| 33 | 132 | 1 | 44 | 3 | 4 | 11 | 4 | 1 |
| 34 | 136 | 1 | 68 | 2 | 4 | 17 | 4 | 1 |
| 35 | 144 | 1 | 72 | 2 | 36 | 2 | 4 | 9 |
| 36 | 144 | 1 | 48 | 3 | 24 | 2 | 12 | 2 |
| 37 | 144 | 1 | 48 | 3 | 16 | 3 | 4 | 4 |
| 38 | 144 | 1 | 16 | 9 | 8 | 2 | 4 | 2 |
| 39 | 152 | 1 | 76 | 2 | 4 | 19 | 4 | 1 |
| 40 | 160 | 1 | 80 | 2 | 40 | 2 | 4 | 10 |
| 41 | 160 | 1 | 80 | 2 | 20 | 4 | 4 | 5 |
| 42 | 160 | 1 | 32 | 5 | 16 | 2 | 4 | 4 |
| 43 | 168 | 1 | 84 | 2 | 28 | 3 | 4 | 7 |
| 44 | 176 | 1 | 88 | 2 | 44 | 2 | 4 | 11 |
| 45 | 184 | 1 | 92 | 2 | 4 | 23 | 4 | 1 |
| 46 | 192 | 1 | 96 | 2 | 48 | 2 | 4 | 12 |
| 47 | 192 | 1 | 96 | 2 | 24 | 4 | 4 | 6 |
| 48 | 192 | 1 | 64 | 3 | 16 | 4 | 4 | 4 |
| 49 | 192 | 1 | 24 | 8 | 8 | 3 | 4 | 2 |
| 50 | 208 | 1 | 104 | 2 | 52 | 2 | 4 | 13 |
| 51 | 216 | 1 | 108 | 2 | 36 | 3 | 4 | 9 |
| 52 | 224 | 1 | 112 | 2 | 56 | 2 | 4 | 14 |
| 53 | 240 | 1 | 120 | 2 | 60 | 2 | 4 | 15 |
| 54 | 240 | 1 | 80 | 3 | 20 | 4 | 4 | 5 |
| 55 | 240 | 1 | 48 | 5 | 16 | 3 | 8 | 2 |
| 56 | 240 | 1 | 24 | 10 | 12 | 2 | 4 | 3 |
| 57 | 256 | 1 | 128 | 2 | 64 | 2 | 4 | 16 |
| 58 | 256 | 1 | 128 | 2 | 32 | 4 | 4 | 8 |
| 59 | 256 | 1 | 16 | 16 | 8 | 2 | 4 | 2 |
| 60 | 264 | 1 | 132 | 2 | 44 | 3 | 4 | 11 |
| 61 | 272 | 1 | 136 | 2 | 68 | 2 | 4 | 17 |
| 62 | 272 | 1 | 68 | 4 | 4 | 17 | 4 | 1 |
| 63 | 272 | 1 | 16 | 17 | 8 | 2 | 4 | 2 |

For example c-SRS=25 selects the following:

| | B_{SRS} = 0 | | B_{SRS} = 1 | | B_{SRS} = 2 | | B_{SRS} = 3 | |
|---|---|---|---|---|---|---|---|---|
| C_{SRS} | m_{SRS, 0} | N₀ | m_{SRS, 1} | N₁ | m_{SRS, 2} | N₂ | m_{SRS, 3} | N₃ |
| 25 | 104 | 1 | 52 | 2 | 4 | 13 | 4 | 1 |

The value in the column m_{SRS,0} defines the maximum sounding bandwidth, in this case 104 RBs. Depending on how other parameters are configured, the actual bandwidth occupied by the SRS resource may not be equal to the maximum sounding bandwidth. The bandwidth occupation and/or frequency domain allocation for an SRS resource is illustrated the example of FIG. 13.

The parameter freqDomainShift (n_{shift} in the above diagram) determines the index of the first RB of maximum sounding bandwidth within the bandwidth part (BWP). The parameter freqDomainPosition (n_{RRC} in the FIG. 13) determines the first PRB of the actual sounding bandwidth. The parameter b-SRS determines the number of PRBs in a given frequency hop within the actual sounding bandwidth. For example, if b-SRS=2, there are m_{SRS,2}=4 RBs in a frequency hop. The size of the actual sounding bandwidth and whether or not frequency hopping is enabled depends on the setting of the parameter b-hop. If b-hop<b-SRS, then frequency hopping is enabled. For example, if b-hop=1, then the actual sounding bandwidth is m_{SRS,1}=52 RBs, and frequency hopping (4 RBs at a time) occurs within all 52 RBs of the actual sounding bandwidth. Hopping is completed within 52/4=13 hops. If b-hop=b-SRS, then no hopping occurs. In this example, only m_{SRS,2}=4 RBs of the actual sounding bandwidth would be sounded. If instead, it is desired to sound all 52 RBs of the actual sounding bandwidth without hopping, then b-hop=b-SRS=1 may be configured.

Although there is significant flexibility for configuring the position of the actual sounding bandwidth within the BWP, one observation is that the RBs of the actual sounding bandwidth are contiguous. Hence, some existing system may lack flexibility due to the actual sounding bandwidth being contiguous.

### SUMMARY

Some embodiments advantageously provide methods, systems, and apparatuses for frequency domain resource allocation (FDRA) such as non-contiguous FDRA.

One or more embodiments provide solutions for semi-statically “linking” at least two reference signal (RS) resources each with contiguous frequency domain resource allocation to form a “linked” resource with non-contiguous frequency domain resource allocation. For examples, this enables allocation of linked CSI-RS resource occupying the two non-contiguous ‘D’ subbands in OFDM symbol(s) configured as D-U-D or allocation of a linked SRS resource occupying in the two non-contiguous ‘U’ subbands in OFDM symbol(s) configured U-D-U.

One or more embodiments provide solutions for semi-statically configuring a single reference signal (RS) resource with non-contiguous frequency domain resource allocation.

According to one aspect, a method performed by a wireless device, WD, configured to communicate with a network node using subband full duplex, SBFD, communications is provided. The method includes, for a symbol in a time slot: receiving from the network node a resource block, RB, configuration; and allocating RBs as reference signal resources according to the received RB configuration, the received RB configuration including one of: a first set of at least one uplink RB separating two sets of at least one downlink RB in the frequency domain, the two sets of at least one downlink RB being configured as a channel state information reference signal, CSI-RS, resource; and a second set of at least one downlink RB separating two sets of at least one uplink RB, the two sets of at least one uplink RB being configured as a sounding reference signal, SRS, resource.

According to this aspect, in some embodiments, the CSI-RS resource includes a plurality of RB sets that are linked and associated with a same resource identification, ID. In some embodiments, the CSI-RS resource includes a plurality of non-contiguous RB sets. In some embodiments, the two sets of at least one downlink RB are linked to and associated with the CSI-RS resource. In some embodiments, the two sets of at least one uplink RB are linked to and associated with the SRS resource. In some embodiments, each set of at least one downlink RB for the CSI-RS resource and each set of at least one uplink RB for the SRS resource includes a plurality of contiguous RBs. In some embodiments, the two sets of at least one downlink RB are linked by a first and second identifier of two separate CSI-RS resources allocated to the two sets of at least one downlink RB, respectively. In some embodiments, a third identifier is associated with the CSI-RS resource and is associated with the first and second identifiers. In some embodiments, the value of the third identifier intersects the set of values of the first and second identifiers. In some embodiments, the value of the third identifier intersects a set of values that is mutually exclusive from the set of values of the first and second identifiers. In some embodiments, the two sets of at least one uplink RB are linked by an identifier of two separate SRS resources, allocated to the two sets of at least one uplink RB, respectively. In some embodiments, a third identifier is associated with the SRS resource and is associated with the first and second identifiers. In some embodiments, the value of the third identifier intersects the set of values of the first and second identifiers. In some embodiments, the value of the third identifier intersects a set of values that is mutually exclusive from the set of values of the first and second identifiers. In some embodiments, allocating the RBs is performed according to a non-contiguous frequency domain resource allocation, FDRA. In some embodiments, the FDRA includes a first parameter to indicate a first starting RB of the received RB configuration within a first one of the two sets of at least one downlink RB or uplink RB. In some embodiments, the FDRA further includes a frequency offset from the first starting RB to indicate a second starting RB of the received RB configuration within a second one of the two sets of at least one downlink RB or uplink RB. In some embodiments, the FDRA further includes a single number of contiguous RBs that are allocated starting from the first starting RB or from both the first starting RB and the second starting RB. In some embodiments, the FDRA further includes a first number of contiguous RBs that are allocated starting from the first starting RB and a second number of contiguous RBs that are allocated from the second starting RB. In some embodiments, the frequency offset is determined implicitly from a separate indication of the RBs in the two sets of at least one DL RBs or the two sets of at least one UL RB. In some embodiments, the FDRA includes a bitmap configured to indicate a mapping of a subset of RBs of a carrier to the RBs in the two sets of at least one uplink RB of the SRS resource and/or a mapping of a subset of RBs of a carrier to the RBs in the two sets of at least one downlink RB of the CSI-RS resource. In some embodiments, the method also includes repeating allocation of the RBs according to the received RB configuration for each of at least one subsequent symbol of the time slot. In some embodiments, the first set of at least one uplink RB has a different number of RBs than the second set of at least one downlink RB. In some embodiments, the UE receives two sets of SRS configuration parameters, wherein the RB allocation within each of the two sets of at least one uplink RB is determined by the two sets of SRS configuration parameters, respectively. In some embodiments, each set of SRS configuration parameters indicates at least a maximum sounding bandwidth, a position of the maximum sounding bandwidth, an actual sounding bandwidth, a position of the actual sounding bandwidth and which portion of the actual sounding bandwidth is occupied by an SRS resource, e.g., by the SRS resource within one of the sets of at least one uplink RB. In some embodiments, the first set of configuration parameters includes all SRS configuration parameters, and the second set of SRS configuration parameters includes a subset of configuration parameters, wherein the RB allocation within the second set of at least one uplink RB is determined based on both the first and second sets of configuration parameters. In some embodiments, the RB allocation within the second set of at least one uplink RB determined based on both the first and second sets of configuration parameters is based on applying a frequency domain offset to at least one of the SRS configuration parameters in the first set of SRS configuration parameters. In some embodiments, the frequency domain offset is an RB offset, In some embodiments, the frequency domain offset is explicitly configured within the second set of SRS configuration parameters. In some embodiments, the frequency domain offset is determined implicitly from a separate indication of the RBs in the two sets of at least one UL RBs.

According to another aspect, a WD configured to communicate with a network node using subband full duplex, SBFD, communications is provided. The WD includes a radio interface configured to receive from the network node a resource block, RB, configuration. The WD also includes processing circuitry in communication with the radio interface and configured to, for each symbol in a time slot allocate resource blocks, RBs, according to the received RB configuration, the received RB configuration including one of: a first set of at least one uplink RB separating two sets of at least one downlink RB in the frequency domain, the two sets of at least one downlink RB being configured as a channel state information reference signal, CSI-RS, resource; and a second set of at least one downlink RB separating two sets of at least one uplink RB, the two sets of at least one uplink RB being configured as a sounding reference signal, SRS, resource.

According to this aspect, in some embodiments, the CSI-RS resource includes a plurality of RB sets that are linked and associated with a same resource identification, ID. In some embodiments, the CSI-RS resource includes a plurality of non-contiguous RB sets. In some embodiments, the two sets of at least one downlink RB are linked to and associated with the CSI-RS resource. In some embodiments, the two sets of at least one uplink RB are linked to and associated with the SRS resource. In some embodiments, each set of at least one downlink RB for the CSI-RS resource and each set of at least one uplink RB for the SRS resource includes a plurality of contiguous RBs. In some embodiments, the two sets of at least one downlink RB are linked by a first and second identifier of two separate CSI-RS resources allocated to the two sets of at least one downlink RB, respectively. In some embodiments, a third identifier is associated with the CSI-RS resource and is associated with the first and second identifiers. In some embodiments, the value of the third identifier intersects the set of values of the first and second identifiers. In some embodiments, the value of the third identifier intersects a set of values that is mutually exclusive from the set of values of the first and second identifiers. In some embodiments, the two sets of at least one uplink RB are linked by an identifier of two separate SRS resources, allocated to the two sets of at least one uplink RB, respectively. In some embodiments, a third identifier is associated with the SRS resource and is associated with the first and second identifiers. In some embodiments, the value of the third identifier intersects the set of values of the first and second identifiers. In some embodiments, the value of the third identifier intersects a set of values that is mutually exclusive from the set of values of the first and second identifiers. In some embodiments, allocating the RBs is performed according to a non-contiguous frequency domain resource allocation, FDRA. In some embodiments, the FDRA includes a first parameter to indicate a first starting RB of the received RB configuration within a first one of the two sets of at least one downlink RB or uplink RB. In some embodiments, the FDRA further includes a frequency offset from the first starting RB to indicate a second starting RB of the received RB configuration within a second one of the two sets of at least one downlink RB or uplink RB. In some embodiments, the FDRA further includes a single number of contiguous RBs that are allocated starting from the first starting RB or from both the first starting RB and the second starting RB. In some embodiments, the FDRA further includes a first number of contiguous RBs that are allocated starting from the first starting RB and a second number of contiguous RBs that are allocated from the second starting RB. In some embodiments, the frequency offset is determined implicitly from a separate indication of the RBs in the two sets of at least one DL RBs or the two sets of at least one UL RB. In some embodiments, the FDRA includes a bitmap configured to indicate a mapping of a subset of RBs of a carrier to the RBs in the two sets of at least one uplink RB of the SRS resource and/or a mapping of a subset of RBs of a carrier to the RBs in the two sets of at least one downlink RB of the CSI-RS resource. In some embodiments, the method also includes repeating allocation of the RBs according to the received RB configuration for each of at least one subsequent symbol of the time slot. In some embodiments, the first set of at least one uplink RB has a different number of RBs than the second set of at least one downlink RB. In some embodiments, the UE receives two sets of SRS configuration parameters, wherein the RB allocation within each of the two sets of at least one uplink RB is determined by the two sets of SRS configuration parameters, respectively. In some embodiments, each set of SRS configuration parameters indicates at least a maximum sounding bandwidth, a position of the maximum sounding bandwidth, an actual sounding bandwidth, a position of the actual sounding bandwidth and which portion of the actual sounding bandwidth is occupied by an SRS resource, e.g., by the SRS resource within one of the sets of at least one uplink RB. In some embodiments, the first set of configuration parameters includes all SRS configuration parameters, and the second set of SRS configuration parameters includes a subset of configuration parameters, wherein the RB allocation within the second set of at least one uplink RB is determined based on both the first and second sets of configuration parameters. In some embodiments, the RB allocation within the second set of at least one uplink RB determined based on both the first and second sets of configuration parameters is based on applying a frequency domain offset to at least one of the SRS configuration parameters in the first set of SRS configuration parameters. In some embodiments, the frequency domain offset is an RB offset, In some embodiments, the frequency domain offset is explicitly configured within the second set of SRS configuration parameters. In some embodiments, the frequency domain offset is determined implicitly from a separate indication of the RBs in the two sets of at least one UL RBs.

According to yet another aspect, a method performed by a network node configured to communicate with a wireless device, WD, using subband full duplex, SBFD, communications is provided. The method includes configuring the WD with a resource block, RB, configuration, the RB configuration including one of: a first set of at least one uplink RB separating two sets of at least one downlink RB in the frequency domain, the two sets of at least one downlink RB being configured as a channel state information reference signal, CSI-RS, resource; and a second set of at least one downlink RB separating two sets of at least one uplink RB, the two sets of at least one uplink RB being configured as a sounding reference signal, SRS, resource.

According to this aspect, in some embodiments, the CSI-RS resource includes a plurality of RB sets that are linked and associated with a same resource identification, ID. In some embodiments, the CSI-RS resource includes a plurality of non-contiguous RB sets. In some embodiments, the RB configuration includes a first parameter to indicate a first starting RB of the RB configuration. In some embodiments, the RB configuration includes a frequency offset from the first starting RB to indicate a second starting RB of the RB configuration. In some embodiments, the RB configuration includes a bitmap configured to indicate a mapping of a subset of RBs of one of the first set of at least one uplink RB and the second set of at least one downlink RB to a respective one of the SRS resource and the CSI-RS resource. In some embodiments, the first set of at least one uplink RB has a different number of RBs than the second set of at least one downlink RB. In some embodiments, the method includes transmitting at least one sounding reference signal, SRS, parameter, each of the at least one SRS parameter relating to a sounding bandwidth for uplink transmission of an SRS on the reference signal resource. In some embodiments, the SRS parameter indicates at least one of a maximum sounding bandwidth, a position of the maximum sounding bandwidth, an actual sounding bandwidth, a position of the actual sounding bandwidth and which portion of the actual sounding bandwidth is occupied by an SRS resource.

According to another aspect, a network node configured to communicate with a wireless device, WD, using subband full duplex, SBFD, communications is provided. The network node includes processing circuitry configured to configure the WD with a resource block, RB, configuration, the RB configuration including one of: a first set of at least one uplink RB separating two sets of at least one downlink RB in the frequency domain, the two sets of at least one downlink RB being configured as a channel state information reference signal, CSI-RS, resource; and a second set of at least one downlink RB separating two sets of at least one uplink RB, the two sets of at least one uplink RB being configured as a sounding reference signal, SRS, resource.

According to this aspect, in some embodiments, the CSI-RS resource includes a plurality of RB sets that are linked and associated with a same resource identification, ID. In some embodiments, the CSI-RS resource includes a plurality of non-contiguous RB sets. In some embodiments, the RB configuration includes a first parameter to indicate a first starting RB of the RB configuration. In some embodiments, the RB configuration includes a frequency offset from the first starting RB to indicate a second starting RB of the RB configuration. In some embodiments, the RB configuration includes a bitmap configured to indicate a mapping of a subset of RBs of one of the first set of at least one uplink RB and the second set of at least one downlink RB to a respective one of the SRS resource and the CSI-RS resource. In some embodiments, the first set of at least one uplink RB has a different number of RBs than the second set of at least one downlink RB. In some embodiments, the network node includes a radio interface in communication with the processing circuitry and configured to transmit at least one sounding reference signal, SRS, parameter, each of the at least one SRS parameter relating to a sounding bandwidth for uplink transmission of an SRS on the reference signal resource. In some embodiments, the SRS parameter indicates at least one of a maximum sounding bandwidth, a position of the maximum sounding bandwidth, an actual sounding bandwidth, a position of the actual sounding bandwidth and which portion of the actual sounding bandwidth is occupied by an SRS resource.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an example radio resource in NR;

FIG. 2 is a diagram of a subframe with 14 OFDM symbols;

FIG. 3 is a diagram of an example of a FDD system;

FIG. 4 is a diagram of an example of a TDD system;

FIG. 5 is a diagram of an example of a half-duplex FDD system;

FIG. 6 is a diagram of an uplink/downlink time/frequency structure in case of FDD or TDD;

FIG. 7 is a diagram of an example TDD DL/UL pattern;

FIG. 8 is a diagram of example cell-specific TDD DL/UL patterns;

FIG. 9 is a diagram of a TDD carrier or carrier systems;

FIG. 10 is a diagram of subband full duplex systems;

FIG. 11 is a diagram of a TDD antenna array with 32 cross-polarized antenna elements (64 elements in total);

FIG. 12 is a diagram of an example antenna architecture 1 for SBFD systems;

FIG. 13 is a diagram of an example frequency domain allocation for a SRS resource;

FIG. 14a is one example of a configuration of 3 RB sets in an SBFD symbol;

FIG. 14b is another example of a configuration of 3 RB sets in an SBFD symbol;

FIG. 15 is a schematic diagram of an example network architecture illustrating a communication system connected via an intermediate network to a host computer according to the principles in the present disclosure;

FIG. 16 is a block diagram of a host computer communicating via a network node with a wireless device over an at least partially wireless connection according to some embodiments of the present disclosure;

FIG. 17 is a flowchart illustrating example methods implemented in a communication system including a host computer, a network node and a wireless device for executing a client application at a wireless device according to some embodiments of the present disclosure;

FIG. 18 is a flowchart illustrating example methods implemented in a communication system including a host computer, a network node and a wireless device for receiving user data at a wireless device according to some embodiments of the present disclosure;

FIG. 19 is a flowchart illustrating example methods implemented in a communication system including a host computer, a network node and a wireless device for receiving user data from the wireless device at a host computer according to some embodiments of the present disclosure;

FIG. 20 is a flowchart illustrating example methods implemented in a communication system including a host computer, a network node and a wireless device for receiving user data at a host computer according to some embodiments of the present disclosure;

FIG. 21 is a flowchart of an example process in a network node according to some embodiments of the present disclosure;

FIG. 22 is a flowchart of an example process in a wireless device according to some embodiments of the present disclosure;

FIG. 23 is a flowchart of another example process in a network node according to some embodiments of the present disclosure;

FIG. 24 is a flowchart of another example process in a wireless device according to some embodiments of the present disclosure;

FIG. 25 is a diagram of an example of logically linking two CSI-RS resources to create a logical linked CSI-RS resource with non-contiguous frequency domain resource allocation according to some embodiments of the present disclosure;

FIG. 26 is a diagram of an example partition of CSI-RS resource ID space and linking of resource IDs according to some embodiments of the present disclosure;

FIG. 27 is a diagram of an example single CSI-RS resource with non-contiguous FDRA according to some embodiments of the present disclosure; and

FIG. 28 is a diagram of an example single SRS resource with non-contiguous FDRA according to some embodiments of the present disclosure.

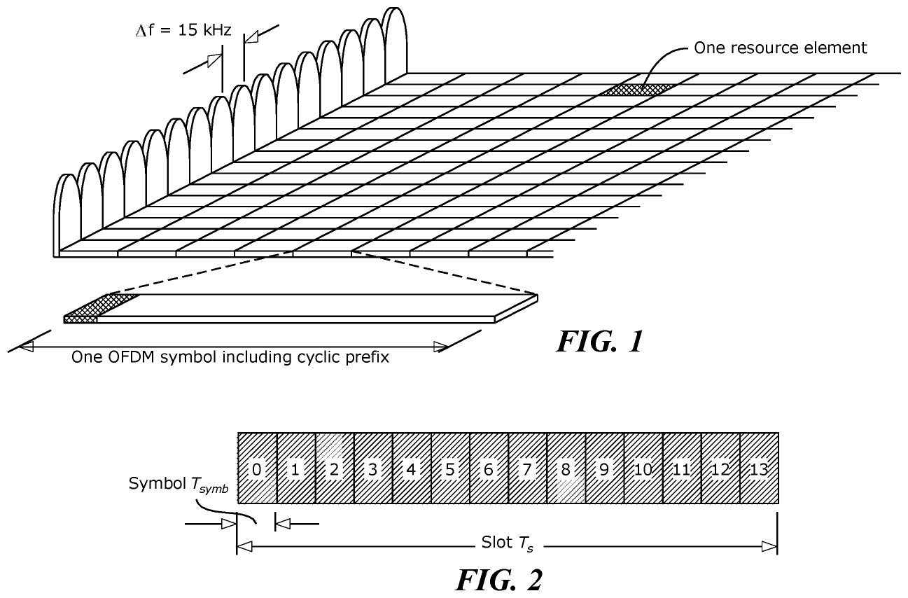

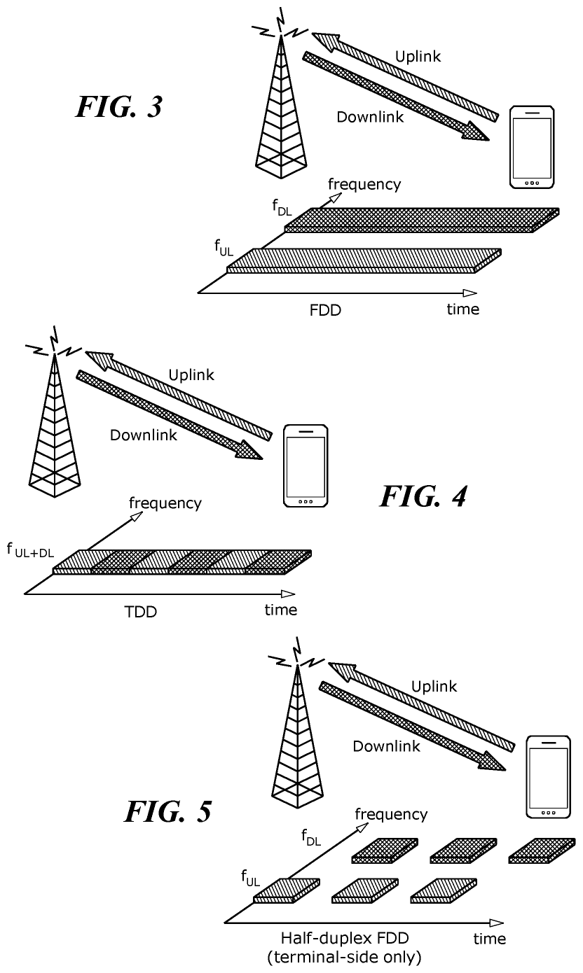

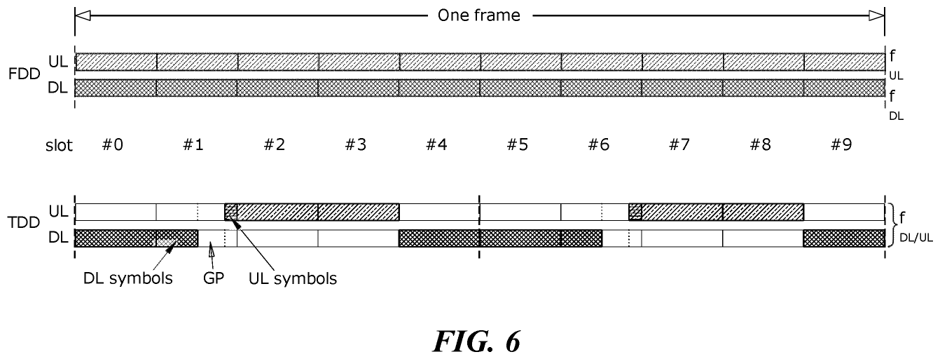

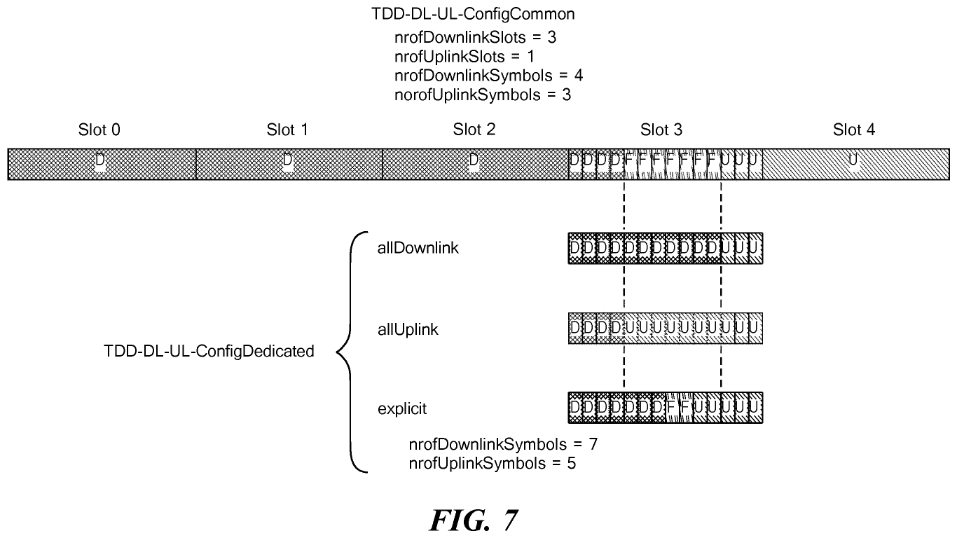

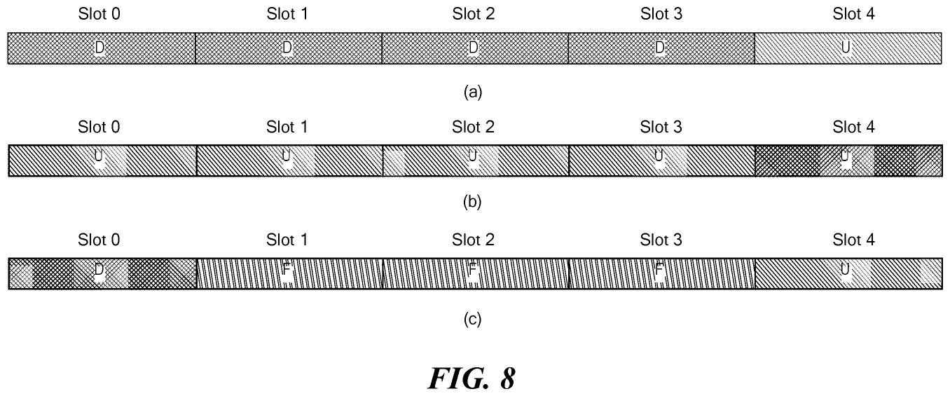

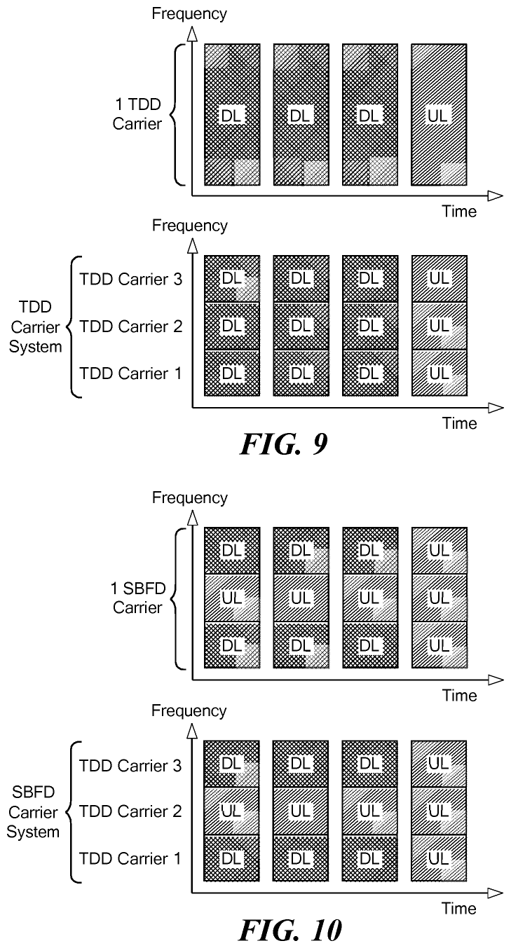

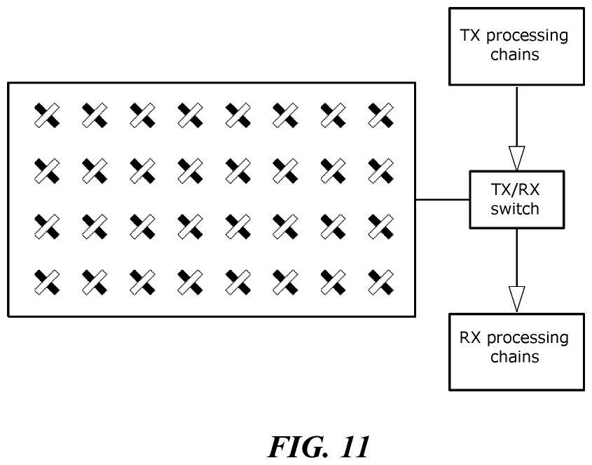

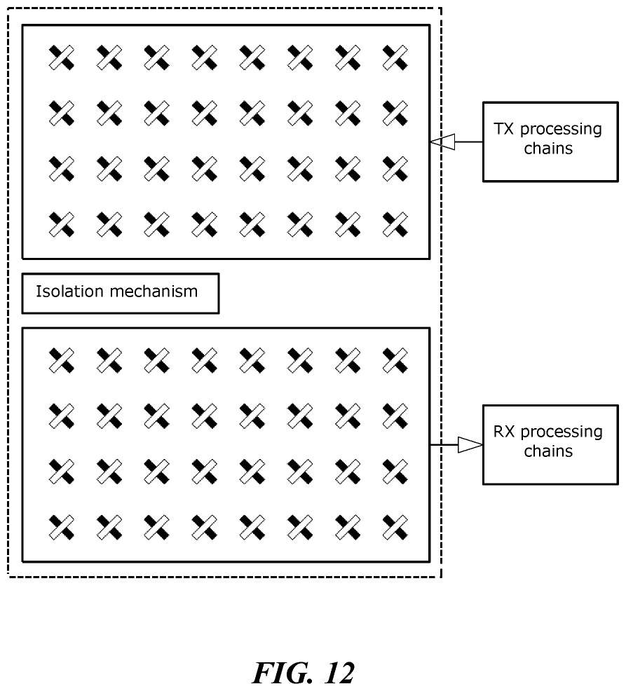

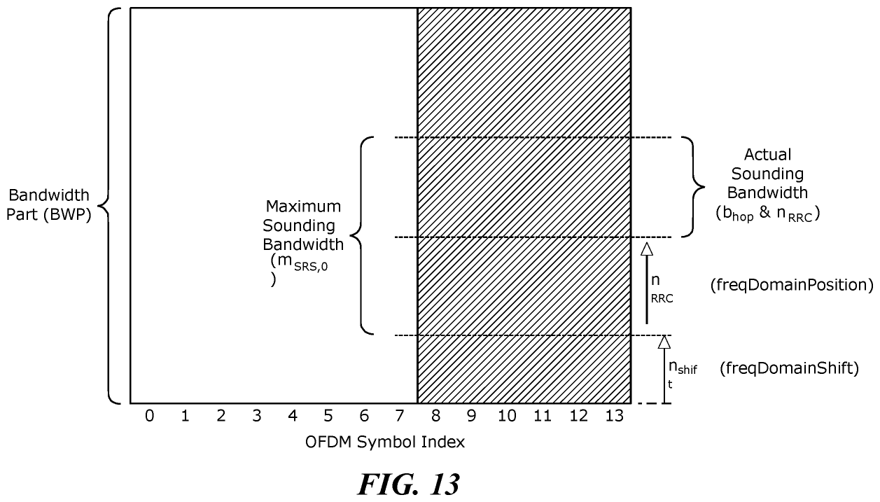

### DETAILED DESCRIPTION

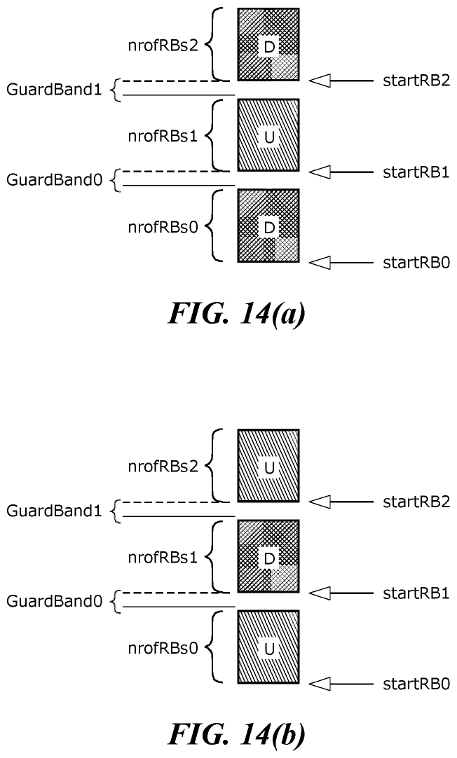

In some example systems, methods are described for configuration of one or more OFDM symbols of a slot with two or more “RB sets” where each RB set corresponds to a frequency domain subband and has a defined transmission direction (‘D’ for downlink or ‘U’ for uplink). The RB sets may have gaps between them that serve as guardbands where neither DL or UL transmission occurs. FIGS. 14(a) and 14(b) are diagrams illustrating two example RB set configurations, one with D-U-D configuration and the other with U-D-U configuration.

Methods are disclosed for an SBFD capable wireless device to handle the case when a configured CSI-RS resource overlaps the guardband(s) and/or ‘U’ RB set in an SBFD symbol with D-U-D configuration (FIG. 14a, or a configured SRS resource overlaps the guardbands and/or ‘D’ RB set within an SBFD symbol with U-D-U configuration (FIG. 14b). These described methods may be summarized as “dropping rules” such that the wireless device drops/ignores/punctures the RBs that overlap. These methods are targeted for CSI-RS and SRS resource configuration using the existing 3GPP specifications which support only contiguous RB allocation in the frequency domain. However, these existing systems do not provide a mechanism to configure a CSI-RS or SRS resource with a non-contiguous frequency domain allocation, which may be beneficial for a carrier configured for subband full duplex operation for which there are at least two non-contiguous ‘D’ subbands or two non-contiguous ‘U’ subbands.

One or more embodiments described herein solves at least a portion of the problem describe above by, for example, providing one or more methods of configuring reference signal (RS) resources with a non-contiguous frequency domain resource allocation in OFDM symbol(s) of a carrier configured for sub-band full duplex (SBFD) operation, thereby providing flexibility in the configuration of reference signal resource allocations such as to, for example, match the subband configuration within a subband full duplex system.

Before describing in detail example embodiments, it is noted that the embodiments reside primarily in combinations of apparatus components and processing steps related to frequency domain resource allocation (FDRA) such as non-contiguous FDRA. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide frequency domain resource allocation (FDRA) such as, for example, non-contiguous FDRA.

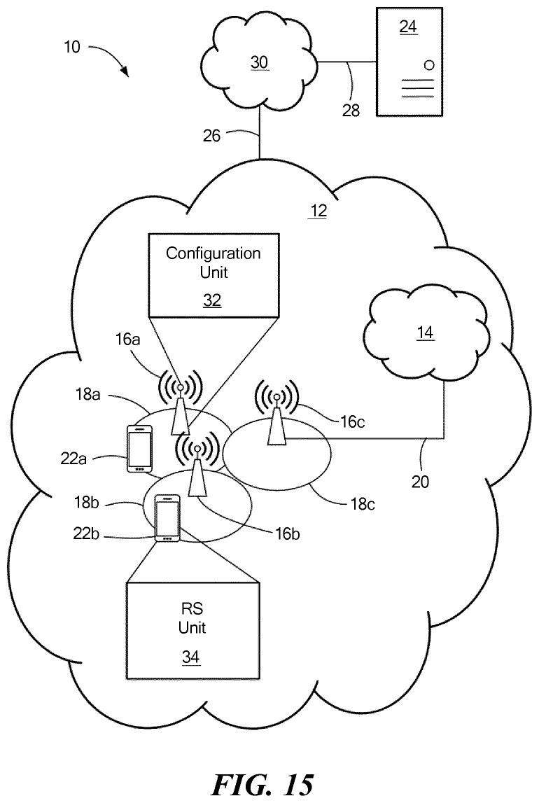

Referring again to the drawing figures, in which like elements are referred to by like reference numerals, there is shown in FIG. 15 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 15 as a whole enables connectivity between one of the connected WDs 22a, 22b and the host computer 24. The connectivity may be described as an over-the-top (OTT) connection. The host computer 24 and the connected WDs 22a, 22b may be configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to perform one or more network node 16 functions as described herein such as with respect to frequency domain resource allocation (FDRA) such as, for example, non-contiguous FDRA. A wireless device 22 is configured to include a RS unit 34 which is configured to perform one or more wireless device 22 functions as described herein such as with respect to frequency domain resource allocation (FDRA) such as, for example, non-contiguous FDRA.

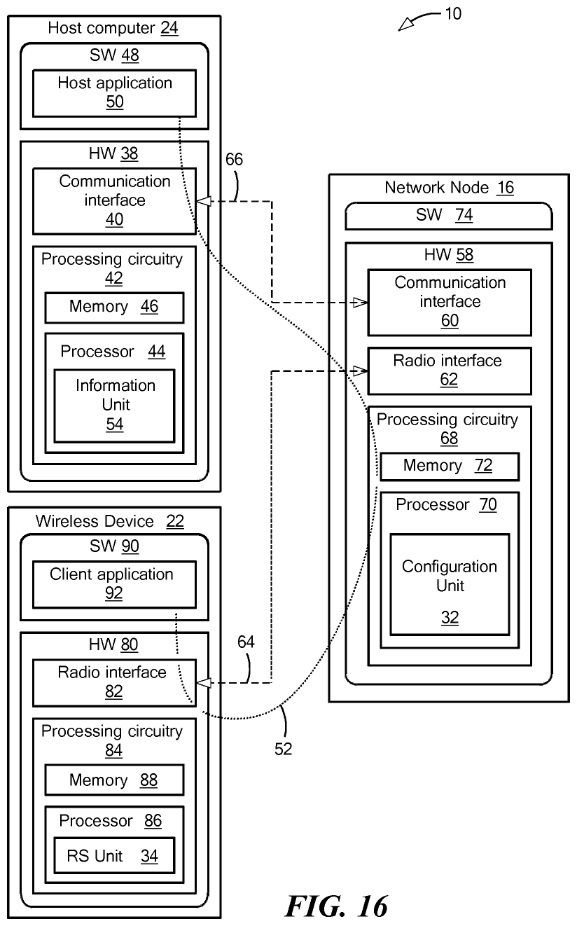

Example implementations, in accordance with an embodiment, of the WD 22, network node 16 and host computer 24 discussed in the preceding paragraphs will now be described with reference to FIG. 16. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of: determine, analyze, forward, relay, transmit, receive, store, modify, etc. information related to frequency domain resource allocation (FDRA) such as, for example, non-contiguous FDRA.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform one or more network node 16 functions as described herein such as with respect to frequency domain resource allocation (FDRA) such as, for example, non-contiguous FDRA.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a RS unit 34 configured to perform one or more wireless device 22 functions as described herein such as with respect to frequency domain resource allocation (FDRA) such as, for example, non-contiguous FDRA.

In some embodiments, the inner workings of the network node 16, WD 22, and host computer 24 may be as shown in FIG. 16 and independently, the surrounding network topology may be that of FIG. 15.

In FIG. 16, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 15 and 16 show various “units” such as configuration unit 32, and RS unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

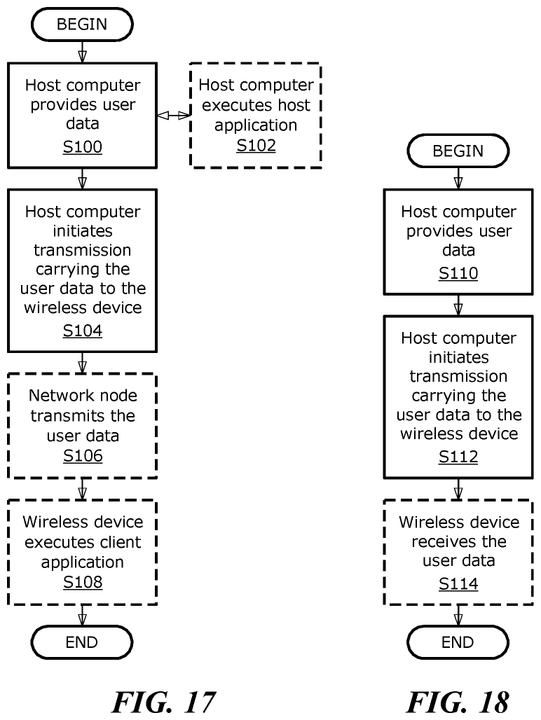

FIG. 17 is a flowchart illustrating an example method implemented in a communication system, such as, for example, the communication system of FIGS. 15 and 16, in accordance with one embodiment. The communication system may include a host computer 24, a network node 16 and a WD 22, which may be those described with reference to FIG. 16. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 18 is a flowchart illustrating an example method implemented in a communication system, such as, for example, the communication system of FIG. 15, in accordance with one embodiment. The communication system may include a host computer 24, a network node 16 and a WD 22, which may be those described with reference to FIGS. 15 and 16. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

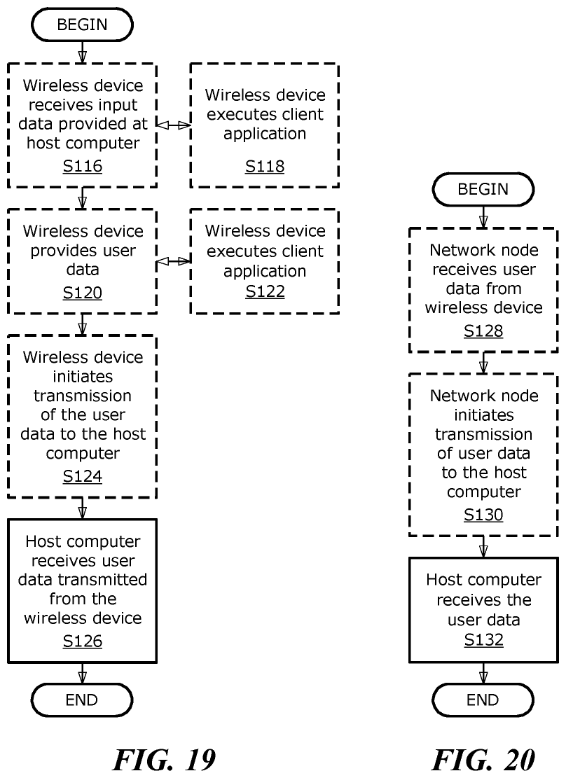

FIG. 19 is a flowchart illustrating an example method implemented in a communication system, such as, for example, the communication system of FIG. 15, in accordance with one embodiment. The communication system may include a host computer 24, a network node 16 and a WD 22, which may be those described with reference to FIGS. 15 and 16. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 20 is a flowchart illustrating an example method implemented in a communication system, such as, for example, the communication system of FIG. 15, in accordance with one embodiment. The communication system may include a host computer 24, a network node 16 and a WD 22, which may be those described with reference to FIGS. 15 and 16. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

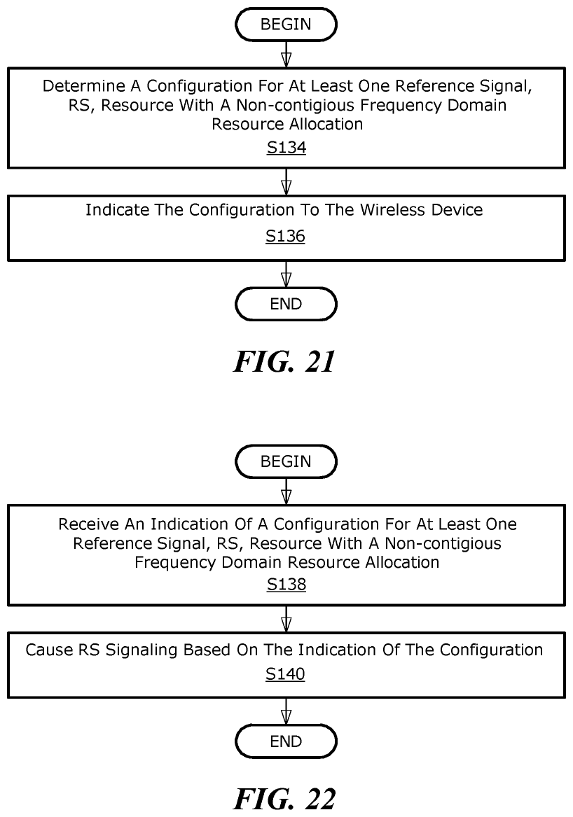

FIG. 21 is a flowchart of an example process in a network node 16 according to one or more embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to determine (Block S134) a configuration for at least one reference signal, RS, resource with a non-contiguous frequency domain resource allocation, as described herein. Network node 16 is configured to indicate the configuration to the wireless device 22, as described herein.

According to one or more embodiments, the at least one RS resource corresponds to at least a first RS resource and a second RS resource each with a contiguous frequency domain resource allocation, where the determining of the configuration includes logically links at least the first RS resource and the second RS resource to logically form a linked resource with a non-contiguous frequency domain resource allocation. According to one or more embodiments, the first RS resource is associated with a first identifier, ID, and the second RS resource is associated with a second ID, where the logically formed link resource is associated with a third ID different from the first and second IDs. According to one or more embodiments, the at least one RS resource is a single RS resource.

According to one or more embodiments, the single RS resources is associate with a single identifier. According to one or more embodiments, the determining of the configuration includes configuring at least one of: a maximum sounding bandwidth, a position of the maximum sounding bandwidth within a bandwidth part, a first sounding bandwidth, a position of the first sounding bandwidth within the maximum sounding bandwidth, and which portion of the actual sounding bandwidth is occupied by a sounding reference signal, SRS, resource. According to one or more embodiments, the RS resource is a one of a channel state information-reference signal, CSI-RS, resource and sounding reference signal, SRS, resource.

FIG. 22 is a flowchart of an example process in a wireless device 22 according to some embodiments of the present disclosure. One or more blocks described herein may be performed by one or more elements of wireless device 22 such as by one or more of processing circuitry 84 (including the RS unit 34), processor 86, radio interface 82 and/or communication interface 60. Wireless device 22 is configured to receive (Block S138) an indication of a configuration for at least one reference signal, RS, resource with a non-contiguous frequency domain resource allocation, as described herein. Wireless device 22 is configured to cause RS signaling based on the indication of the configuration, as described herein.

According to one or more embodiments, the at least one RS resource corresponds to at least a first RS resource and a second RS resource each with a contiguous frequency domain resource allocation where the determining of the configuration includes logically links at least the first RS resource and the second RS resource to logically form a linked resource with a non-contiguous frequency domain resource allocation. According to one or more embodiments, the first RS resource is associated with a first identifier, ID, and the second RS resource is associated with a second ID where the logically formed link resource is associated with a third ID different from the first and second IDs. According to one or more embodiments, the at least one RS resource is a single RS resource.

According to one or more embodiments, the single RS resources is associate with a single identifier. According to one or more embodiments, the configuration configures at least one of a maximum sounding bandwidth, a position of the maximum sounding bandwidth within a bandwidth part, a first sounding bandwidth, a position of the first sounding bandwidth within the maximum sounding bandwidth, and which portion of the actual sounding bandwidth is occupied by a sounding reference signal, SRS, resource. According to one or more embodiments, the RS resource is a one of a channel state information-reference signal, CSI-RS, resource and sounding reference signal, SRS, resource.

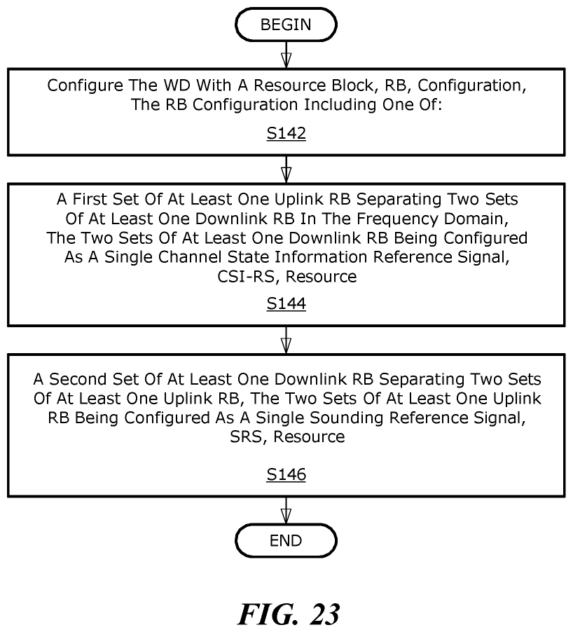

FIG. 23 is a flowchart of another example process in a network node 16 according to one or more embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to configure the WD with a resource block, RB, configuration, the RB configuration including one of (Block S142): a first set of at least one uplink RB separating two sets of at least one downlink RB in the frequency domain, the two sets of at least one downlink RB being configured as a channel state information reference signal, CSI-RS, resource (Block S144); and a second set of at least one downlink RB separating two sets of at least one uplink RB, the two sets of at least one uplink RB being configured as a sounding reference signal, SRS, resource (Block S146).

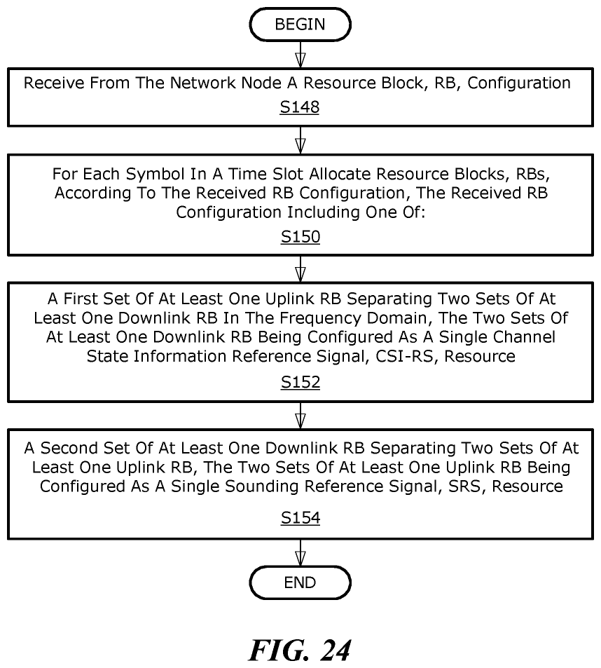

According to this aspect, in some embodiments, the CSI-RS resource includes a plurality of RB sets that are linked and associated with a same resource identification, ID. In some embodiments, the CSI-RS resource includes a plurality of contiguous RB sets. In some embodiments, the RB configuration includes a first parameter to indicate a first starting RB of the RB configuration. In some embodiments, the RB configuration includes a frequency offset from the first starting RB to indicate a second starting RB of the RB configuration. In some embodiments, the RB configuration includes a bitmap configured to indicate a mapping of a subset of RBs of one of the first set of at least one uplink RB and the second set of at least one downlink RB to a respective one of the SRS resource and the CSI-RS resource. In some embodiments, the first set of at least one uplink RB has a different number of RBs than the second set of at least one downlink RB. In some embodiments, the method includes transmitting at least one sounding reference signal, SRS, parameter, each of the at least one SRS parameter relating to a sounding bandwidth for uplink transmission of an SRS on the reference signal resource. In some embodiments, the SRS parameter indicates at least one of a maximum sounding bandwidth, a position of the maximum sounding bandwidth, an actual sounding bandwidth, a position of the actual sounding bandwidth and which portion of the actual sounding bandwidth is occupied by an SRS resource. FIG. 24 is a flowchart of an example process in a wireless device 22 according to some embodiments of the present disclosure. One or more blocks described herein may be performed by one or more elements of wireless device 22 such as by one or more of processing circuitry 84 (including the RS unit 34), processor 86, radio interface 82 and/or communication interface 60. Wireless device 22 is configured to, for a symbol in a time slot: receiving from the network node a resource block, RB, configuration (Block S148); and allocating RBs as reference signal resources according to the received RB configuration, the received RB configuration including one of (Block S150): a first set of at least one uplink RB separating two sets of at least one downlink RB in the frequency domain, the two sets of at least one downlink RB being configured as a channel state information reference signal, CSI-RS, resource (Block S152); and a second set of at least one downlink RB separating two sets of at least one uplink RB, the two sets of at least one uplink RB being configured as a sounding reference signal, SRS, resource (Block S154).

In some embodiments, the CSI-RS resource includes a plurality of RB sets that are linked and associated with a same resource identification, ID. In some embodiments, the CSI-RS resource includes a plurality of contiguous RB sets. In some embodiments, the two sets of at least one downlink RB are linked to and associated with the CSI-RS resource. In some embodiments, the two sets of at least one uplink RB are linked to and associated with the SRS resource. In some embodiments, each set of at least one downlink RB for the CSI-RS resource and each set of at least one uplink RB for the SRS resource includes a plurality of contiguous RBs. In some embodiments, the two sets of at least one downlink RB are linked by a first and second identifier of two separate CSI-RS resources allocated to the two sets of at least one downlink RB, respectively. In some embodiments, a third identifier is associated with the CSI-RS resource and is associated with the first and second identifiers. In some embodiments, the value of the third identifier intersects the set of values of the first and second identifiers. In some embodiments, the value of the third identifier intersects a set of values that is mutually exclusive from the set of values of the first and second identifiers. In some embodiments, the two sets of at least one uplink RB are linked by an identifier of two separate SRS resources, allocated to the two sets of at least one uplink RB, respectively. In some embodiments, a third identifier is associated with the SRS resource and is associated with the first and second identifiers. In some embodiments, the value of the third identifier intersects the set of values of the first and second identifiers. In some embodiments, the value of the third identifier intersects a set of values that is mutually exclusive from the set of values of the first and second identifiers. In some embodiments, allocating the RBs is performed according to a non-contiguous frequency domain resource allocation, FDRA. In some embodiments, the FDRA includes a first parameter to indicate a first starting RB of the received RB configuration within a first one of the two sets of at least one downlink RB or uplink RB. In some embodiments, the FDRA further includes a frequency offset from the first starting RB to indicate a second starting RB of the received RB configuration within a second one of the two sets of at least one downlink RB or uplink RB. In some embodiments, the FDRA further includes a single number of contiguous RBs that are allocated starting from the first starting RB or from both the first starting RB and the second starting RB. In some embodiments, the FDRA further includes a first number of contiguous RBs that are allocated starting from the first starting RB and a second number of contiguous RBs that are allocated from the second starting RB. In some embodiments, the frequency offset is determined implicitly from a separate indication of the RBs in the two sets of at least one DL RBs or the two sets of at least one UL RB. In some embodiments, the FDRA includes a bitmap configured to indicate a mapping of a subset of RBs of a carrier to the RBs in the two sets of at least one uplink RB of the SRS resource and/or a mapping of a subset of RBs of a carrier to the RBs in the two sets of at least one downlink RB of the CSI-RS resource. In some embodiments, the method also includes repeating allocation of the RBs according to the received RB configuration for each of at least one subsequent symbol of the time slot. In some embodiments, the first set of at least one uplink RB has a different number of RBs than the second set of at least one downlink RB. In some embodiments, the UE receives two sets of SRS configuration parameters, wherein the RB allocation within each of the two sets of at least one uplink RB is determined by the two sets of SRS configuration parameters, respectively. In some embodiments, each set of SRS configuration parameters indicates at least one of a maximum sounding bandwidth, a position of the maximum sounding bandwidth, an actual sounding bandwidth, a position of the actual sounding bandwidth and which portion of the actual sounding bandwidth is occupied by an SRS resource. In some embodiments, the first set of configuration parameters includes all SRS configuration parameters, and the second set of SRS configuration parameters includes a subset of configuration parameters, wherein the RB allocation within the second set of at least one uplink RB is determined based on both the first and second sets of configuration parameters. In some embodiments, the RB allocation within the second set of at least one uplink RB determined based on both the first and second sets of configuration parameters is based on applying a frequency domain offset to at least one of the SRS configuration parameters in the first set of SRS configuration parameters. In some embodiments, the frequency domain offset is an RB offset, In some embodiments, the frequency domain offset is explicitly configured within the second set of SRS configuration parameters. In some embodiments, the frequency domain offset is determined implicitly from a separate indication of the RBs in the two sets of at least one UL RBs.

Having described the general process flow of arrangements of the disclosure and having provided examples of hardware and software arrangements for implementing the processes and functions of the disclosure, the sections below provide details and examples of arrangements for frequency domain resource allocation (FDRA) such as, for example, non-contiguous FDRA.

Some embodiments provide frequency domain resource allocation (FDRA) such as, for example, non-contiguous FDRA.

In one or more of the following embodiments, an SBFD symbol is a symbol that is configured such that it may be used for SBFD operation, i.e., simultaneous transmission/reception within the same carrier. For example, such an SBFD symbols may be configured with 3 RB sets arranged as D-U-D or arranged as U-D-U. Note that while an SBFD symbol may be used for simultaneous transmission and reception, it is not restricted to simultaneous transmission and reception. At any given time instant, the symbol may be used for only transmission or only reception by a given node in the system.

### Example 1: Linked Reference Signal Resources

This example is described in the context of CSI-RS resources. However, those skilled in the art will recognize that the same principles apply to other reference signal resources, e.g., SRS.

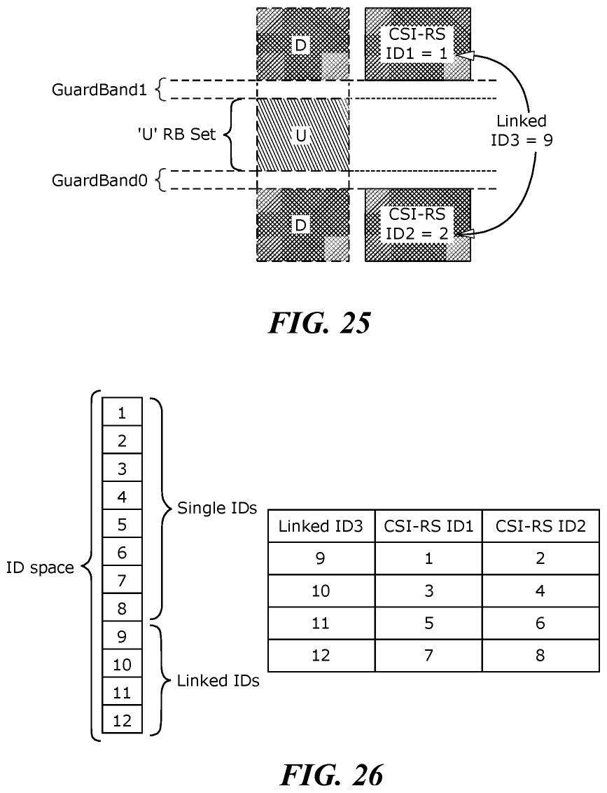

In some embodiments, a CSI-RS resource with non-contiguous frequency domain allocation (FDRA) is created by linking (e.g., logically linking) at least two CSI-RS resources each configured with contiguous allocation. The “linked” CSI-RS resource is then treated (e.g., forms a logically linked resource) as a single CSI-RS resource for any purpose in which CSI-RS is used, e.g., CSI reporting, beam management, etc. FIG. 25 is a diagram illustrating an example of two linked CSI-RS resources, one configured in each of the ‘D’ subbands.

As described herein, each configured CSI-RS resource has an associated ID NZP-CSI-RS-ResourceId which has an index space of 0 . . . 191. To at least in part enable Example 1, the index space is partitioned into two subsets:
The first subset includes of IDs used for referring to a single CSI-RS resource configured with contiguous frequency domain resource allocation as in Rel-17; and
The second subset includes IDs used for referring to a linked CSI-RS resource according to one or more embodiments of the present disclosure.
FIG. 26 is a diagram of an example in which the index space includes 12 IDs. The first 8 may be used to refer to a single CSI-RS resource (e.g., Single IDs), and the last 4 may be used to refer to linked CSI-RS resources (e.g., Linked IDs). The table in the diagram shows an example in which 4 linked CSI-RS resources may be defined using the total index space. In the diagram in FIG. 25, the first row of the table in FIG. 26 is used.

In this embodiment, multiple CSI-RS resources may be configured as per existing (3GPP Rel-17) specifications, with IDs configured from the first subset of the index space. Then, a new RRC parameter (outside the CSI-RS resource configuration) is defined which provides the linked IDs as shown in the example table in FIG. 26. In one non-limiting example, the RRC parameter may indicate and/or be of 3 lists of equal length corresponding to the 3 columns in the table.

With this embodiment, it is possible to support both legacy wireless device 22 (3GPP Rel-17 and prior Release version(s)) and new (SBFD capable wireless devices 22). Wireless devices 22 capable of SBFD operation may be configured with the new parameter (e.g., RRC parameter) that provides the resource ID linking. For such wireless devices 22, the individual CSI-RS resources may be configured with IDs drawn from the first subset of IDs in the index space. Legacy wireless devices 22 are not configured with the “linking” parameter. Such wireless devices 22 are configured with CSI-RS resource IDs from the full index space.

In a variation of this embodiment, the index space (e.g., limited to 192) is extended to be larger (e.g., greater than 192), and only wireless devices 22 capable of SBFD operation have access to the extended space which is used to provide IDs for the linked CSI-RS resources.

As previously described herein, a CSI-RS resource ID is used in several ways. One example is the formation of a CSI-RS resource set which is constructed by configuring a list of CSI-RS resource IDs. Another example is for configuration of TCI states in which case the TCI state configuration contains a CSI-RS resource ID. In this embodiment, for new SBFD capable wireless devices 22, the same approach is used, but instead of configuring an ID value corresponding to a single CSI-RS resource, an ID value corresponding to a linked CSI-RS resource ID is used, and this linked ID is drawn/indicated/determined from the second subset of the partitioned ID space.

### Example 2: Non-Contiguous Frequency Domain Resource Allocation for CSI-RS

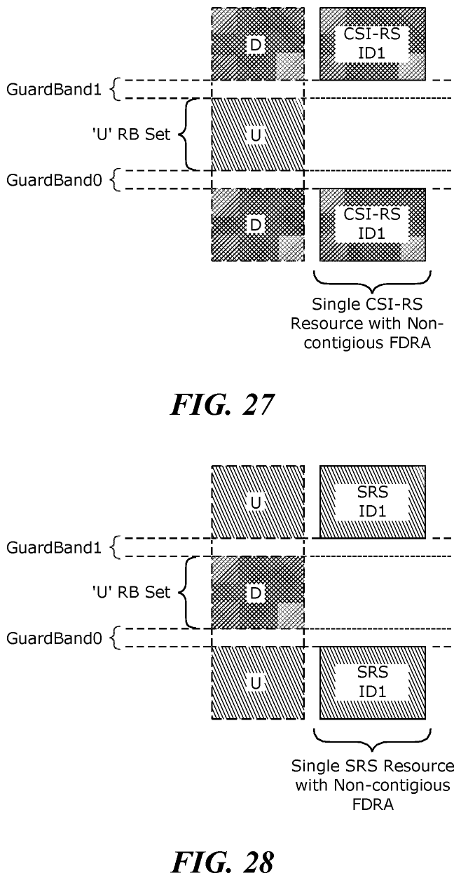

In contrast to Embodiment 1, in this embodiment, a single CSI-RS resource is defined with non-contiguous frequency domain resource allocation (FDRA) rather than linking two resources, as illustrated in the example of FIG. 27.

As described herein, current specifications allow only configuration of contiguous FDRA. A parameter CSI-FrequencyOccupation provides a start RB and a number of contiguous RBs for this contiguous allocation.

In one non-limiting example of this embodiment, at least a second instance of this parameter is configured within a CSI-RS resource. This instance may be optional such that it may be configured only for new, SBFD capable WDs. The second instance may provide second values of the starting RB and number of RBs. This is shown below where the second non-contiguous frequency domain allocation is in bolded text. With this approach a non-contiguous FDRA may be configured allowing allocation to the two non-contiguous ‘D’ subbands in FIG. 27.

```
CSI-RS-ResourceMapping ::= SEQUENCE {
  frequencyDomainAllocation CHOICE {
    row1 BIT STRING (SIZE (4)),
    row2 BIT STRING (SIZE (12)),
    row4 BIT STRING (SIZE (3)),
    other BIT STRING (SIZE (6))
  },
  nrofPorts ENUMERATED {p1,p2,p4,p8,p12,p16,p24,p32},
  firstOFDMSymbolInTimeDomain INTEGER (0..13),
  firstOFDMSymbolInTimeDomain2 INTEGER (2..12)
OPTIONAL, -- Need R
  cdm-Type ENUMERATED {noCDM, fd-CDM2, cdm4-FD2-TD2,
cdm8-FD2-TD4},
  density CHOICE {
    dot5 ENUMERATED {evenPRBs, oddPRBs},
    one NULL,
    three NULL,
    spare NULL
  },
  freqBand CSI-FrequencyOccupation,
  freqBand2 CSI-FrequencyOccupation,
                              OPTIONAL -CondSBFD
  ...
}
```

In a variation of this embodiment, a non-contiguous frequency domain allocation may be configured using a new parameter that defines a bitmap that may be used for new (SBFD) capable wireless devices 22 instead of the existing parameter that defines a start RB and size for a contiguous allocation. Each bit in the bitmap maps to an RB or group of RBs or at least one RB within a carrier or bandwidth part (BWP). In one example, a ‘1’ in the bitmap indicates that the corresponding RB or group of RBs is allocated to the CSI-RS resource.

In another variation, the existing parameter CSI-FrequencyOccupation is reused, and a new parameter that indicates a frequency offset is added to the CSI-RS configuration. The frequency offset indicates an offset (in RBs) to the start RB such that the frequency allocation includes the following two RB ranges:
Range 1: {startRB . . . startRB+nrofRBs}; and
Range 2: {startRB+RBOffset . . . startRB+RBOffset+nrofRBs}
   The value of startRB and RBOffset may be configured such that startRB falls in the first ‘D’ subband, and startRB+RBOffset falls in the 2nd ‘D’ subband. Referring back to FIG. 25, the ‘D’ subbands may be configured through a parameter that indicates an RB set for each subband (FIG. 14a shows an example RB set configuration).

In a variation of one or more embodiments described herein, the RBOffset is not configured explicitly, but instead is determined by the wireless device 22 implicitly via the RB set configuration. For example, the wireless device 22 determines RBOffset as the first RB of the 2nd ‘D’ RB set. Optionally, an additional 1-bit flag may be added to the CSI-RS configuration to indicate whether or not the wireless device 22 may determine the RBOffset. If the flag indicates that wireless device 22 should not, then CSI-RS may be allocated only to the first ‘D’ RB set.

### Example 3: Non-Contiguous Frequency Domain Resource Allocation for SRS

In some embodiments, a single SRS resource is defined with non-contiguous frequency domain resource allocation (FDRA) rather than linking two resources. This is illustrated in the example of FIG. 28.

As described herein, existing specifications allow only for both the maximum and actual sounding bandwidth to occupy a set of contiguous RBs. Five parameters may control one of more of the following:
Maximum sounding bandwidth;
Position of the maximum sounding bandwidth within the BWP;
Actual sounding bandwidth;
Position of the actual sounding bandwidth within the maximum sounding bandwidth; and/or
Which portion of the actual sounding bandwidth is occupied by the SRS resource, either with or without frequency hopping.
In some embodiments, 2^{nd} instances of all 5 of these parameters may be configured, allowing for full flexibility of the bandwidth configuration and hopping behavior within each ‘U’ subband. These instances may be optional such that they may be configured only for new, SBFD capable WDs. This is illustrated below where at least some of these parameters are indicated in bold text.

```
SRS-Resource ::= SEQUENCE {
...
  freqDomainPosition INTEGER (0..67),
  freqDomainShift INTEGER (0..268),
  freqHopping SEQUENCE {
    c-SRS INTEGER (0..63),
    b-SRS INTEGER (0..3),
    b-hop INTEGER (0..3)
  }
  freqDomainPosition2 INTEGER (0..67),
                  OPTIONAL -CondSBFD
  freqDomainShift2 INTEGER (0..268),
                  OPTIONAL -CondSBFD
  freqHopping2 SEQUENCE {
    c-SRS INTEGER (0..63),
    b-SRS INTEGER (0..3),
    b-hop INTEGER (0..3)
}
                                      OPTIONAL -CondSBFD
```

In some embodiments, a 2^{nd} instance is not defined for all 5 parameters, trading a limitation of flexibility for reduced signaling overhead. For example, a 2^{nd} instance of only the parameter freqDomainShift may be defined. In this case, the common value of the parameter c-SRS is configured such that the maximum sounding bandwidth is less than or equal to the bandwidth of one of the ‘U’ subbands. Then the 2^{nd} instance of freqDomainShift allows the sounding bandwidth to be configured in each of the two non-contiguous ‘U’ subbands. In this case, the hopping behavior controlled by the remaining parameters may be identical in each ‘U’ subband.

In some embodiments, rather than explicitly defining freqDomainShift2 in the SRS configuration, the wireless device 22 determines freqDomainShift2 implicitly via the RB set configuration. Referring again to FIG. 14b, an example RB set configuration is illustrated. For example, the wireless device 22 implicitly determines freqDomainShift2 as the first RB of the 2^{nd} ‘U’ RB set. Optionally, an additional 1-bit flag may be added to the SRS configuration to indicate whether wireless device 22 should determine freqDomainShift2. If the flag indicates that it should not, then SRS may be allocated only to the first ‘U’ RB set.

In some embodiments, a 2^{nd} instance of only the parameter freqDomainPostion is either explicitly defined in the SRS configuration or implicitly determined by the wireless device 22. In this case, the common value of the parameter c-SRS is configured such that the maximum sounding bandwidth spans both ‘U’ subbands. Then, the parameter freqDomainPostion2 (explicitly defined or implicitly determined) allows the actual sounding bandwidth within the maximum sounding to be shifted for the 2^{nd} ‘U’ subband. In this case, the other parameters should be configured to ensure that the actual sounding bandwidth is less than the maximum sounding bandwidth. Again, the hopping behavior controlled by the remaining parameters may be identical in each ‘U’ subband. Optionally, for the case of implicit determination, an additional 1-bit flag may be added to the SRS configuration to indicate whether the wireless device 22 should determine freqDomainPostion2. If the flag indicates that wireless device 22 should not, then SRS may be allocated only to the first ‘U’ RB set.

Some embodiments may include one or more of the following:

Embodiment A1. A network node configured to communicate with a wireless device, the network node configured to, and/or comprising a radio interface and/or comprising processing circuitry configured to:
determine a configuration for at least one reference signal, RS, resource with a non-contiguous frequency domain resource allocation; and
indicate the configuration to the wireless device.

Embodiment A2. The network node of Embodiment A1, wherein the at least one RS resource corresponds to at least a first RS resource and a second RS resource each with a contiguous frequency domain resource allocation;
the determining of the configuration includes logically linking at least the first RS resource and the second RS resource to logically form a linked resource with a non-contiguous frequency domain resource allocation.

Embodiment A3. The network node of Embodiment A2, wherein the first RS resource is associated with a first identifier, ID, and the second RS resource is associated with a second ID, the logically formed link resource is associated with a third ID different from the first and second IDs.

Embodiment A4. The network node of Embodiment A1, wherein the at least one RS resource is a single RS resource.

Embodiment A5. The network node of Embodiment A4, wherein the single RS resources is associate with a single identifier.

Embodiment A6. The network node of any one of Embodiments A4-A5, wherein the determining of the configuration includes configuring at least one of:
a maximum sounding bandwidth;
a position of the maximum sounding bandwidth within a bandwidth part;
a first sounding bandwidth;
a position of the first sounding bandwidth within the maximum sounding bandwidth;
which portion of the actual sounding bandwidth is occupied by a sounding reference signal, SRS, resource.

Embodiment A7. The network node of any one of Embodiments A1-A6, wherein the RS resource is a one of a channel state information-reference signal, CSI-RS, resource and sounding reference signal, SRS, resource.

Embodiment B1. A method implemented by a network node that is configured to communicate with a wireless device, the method comprising:
determining a configuration for at least one reference signal, RS, resource with a non-contiguous frequency domain resource allocation; and
indicating the configuration to the wireless device.

Embodiment B2. The method of Embodiment B1, wherein the at least one RS resource corresponds to at least a first RS resource and a second RS resource each with a contiguous frequency domain resource allocation;
the determining of the configuration includes logically linking at least the first RS resource and the second RS resource to logically form a linked resource with a non-contiguous frequency domain resource allocation.

Embodiment B3. The method of Embodiment B2, wherein the first RS resource is associated with a first identifier, ID, and the second RS resource is associated with a second ID, the logically formed link resource is associated with a third ID different from the first and second IDs.

Embodiment B4. The method of Embodiment B1, wherein the at least one RS resource is a single RS resource.

Embodiment B5. The method of Embodiment B4, wherein the single RS resources is associate with a single identifier.

Embodiment B6. The method of any one of Embodiments B4-B5, wherein the determining of the configuration includes configuring at least one of:
a maximum sounding bandwidth;
a position of the maximum sounding bandwidth within a bandwidth part;
a first sounding bandwidth;
a position of the first sounding bandwidth within the maximum sounding bandwidth;
which portion of the actual sounding bandwidth is occupied by a sounding reference signal, SRS, resource.

Embodiment B7. The method of any one of Embodiments B1-B6, wherein the RS resource is a one of a channel state information-reference signal, CSI-RS, resource and sounding reference signal, SRS, resource.

Embodiment C1. A wireless device configured to communicate with a network node, the wireless device configured to, and/or comprising a radio interface and/or processing circuitry configured to:
receive an indication of a configuration for at least one reference signal, RS, resource with a non-contiguous frequency domain resource allocation; and
cause RS signaling based on the indication of the configuration.

Embodiment C2. The wireless device of Embodiment C1, wherein the at least one RS resource corresponds to at least a first RS resource and a second RS resource each with a contiguous frequency domain resource allocation; and
the determining of the configuration includes logically linking at least the first RS resource and the second RS resource to logically form a linked resource with a non-contiguous frequency domain resource allocation.

Embodiment C3. The wireless device of Embodiment C1, wherein the first RS resource is associated with a first identifier, ID, and the second RS resource is associated with a second ID, the logically formed link resource is associated with a third ID different from the first and second IDs.

Embodiment C4. The wireless device of Embodiment C1, wherein the at least one RS resource is a single RS resource.

Embodiment C5. The wireless device of Embodiment C4, wherein the single RS resources is associate with a single identifier.

Embodiment C6. The wireless device of any one of Embodiments C4-C5, wherein the configuration configures at least one of:
a maximum sounding bandwidth;
a position of the maximum sounding bandwidth within a bandwidth part;
a first sounding bandwidth;
a position of the first sounding bandwidth within the maximum sounding bandwidth;
which portion of the actual sounding bandwidth is occupied by a sounding reference signal, SRS, resource.

Embodiment C7. The wireless device of any one of Embodiments C1-C6, wherein the RS resource is a one of a channel state information-reference signal, CSI-RS, resource and sounding reference signal, SRS, resource.

Embodiment D1. A method implemented by a wireless device that is configured to communicate with a network node, the method comprising:
receiving an indication of a configuration for at least one reference signal, RS, resource with a non-contiguous frequency domain resource allocation; and
causing RS signaling based on the indication of the configuration.

Embodiment D2. The method of Embodiment D1, wherein the at least one RS resource corresponds to at least a first RS resource and a second RS resource each with a contiguous frequency domain resource allocation; and
the determining of the configuration includes logically linking at least the first RS resource and the second RS resource to logically form a linked resource with a non-contiguous frequency domain resource allocation.

Embodiment D3. The method of Embodiment D1, wherein the first RS resource is associated with a first identifier, ID, and the second RS resource is associated with a second ID, the logically formed link resource is associated with a third ID different from the first and second IDs.

Embodiment D4. The method of Embodiment D1, wherein the at least one RS resource is a single RS resource.

Embodiment D5. The method of Embodiment D4, wherein the single RS resources is associate with a single identifier.

Embodiment D6. The method of any one of Embodiments D4-D5, wherein the configuration configures at least one of:
a maximum sounding bandwidth;
a position of the maximum sounding bandwidth within a bandwidth part;
a first sounding bandwidth;
a position of the first sounding bandwidth within the maximum sounding bandwidth;
which portion of the actual sounding bandwidth is occupied by a sounding reference signal, SRS, resource.

Embodiment D7. The method of any one of Embodiments D1-D6, wherein the RS resource is a one of a channel state information-reference signal, CSI-RS, resource and sounding reference signal, SRS, resource.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method performed by a wireless device, WD, configured to communicate with a network node using subband full duplex, SBFD, communications, the method comprising, for a symbol in a time slot:
receiving from the network node a resource block, RB, configuration; and
allocating RBs as reference signal resources according to the received RB configuration, the received RB configuration including one of:
a first set of at least one uplink RB separating two sets of at least one downlink RB in the frequency domain, the two sets of at least one downlink RB being configured as a channel state information reference signal, CSI-RS, resource; and
a second set of at least one downlink RB separating two sets of at least one uplink RB, the two sets of at least one uplink RB being configured as a sounding reference signal, SRS, resource.

2. The method of claim 1, wherein the CSI-RS resource includes a plurality of RB sets that are linked and associated with a same resource identification, ID.

3. The method of claim 1, wherein the CSI-RS resource includes a plurality of non-contiguous RB sets.

4. The method of claim 1, wherein the two sets of at least one downlink RB are linked to and associated with the CSI-RS resource.

5. The method of claim 1, wherein the two sets of at least one uplink RB are linked to and associated with the SRS resource.

6. The method of claim 1, wherein each set of at least one downlink RB for the CSI-RS resource and each set of at least one uplink RB for the SRS resource includes a plurality of contiguous RBs.

7. The method of claim 1, wherein the two sets of at least one downlink RB are linked by a first and second identifier of two separate CSI-RS resources allocated to the two sets of at least one downlink RB, respectively.

8. The method of claim 7, wherein a third identifier is associated with the CSI-RS resource and is associated with the first and second identifiers.

9. The method of claim 8, wherein the value of the third identifier intersects the set of values of the first and second identifiers.

10. The method of claim 8, wherein the value of the third identifier intersects a set of values that is mutually exclusive from the set of values of the first and second identifiers.

11. The method of claim 1, wherein the two sets of at least one uplink RB are linked by an identifier of two separate SRS resources, allocated to the two sets of at least one uplink RB, respectively.

12. The method of claim 11, wherein a third identifier is associated with the SRS resource and is associated with the first and second identifiers.

13. The method of claim 12, wherein the value of the third identifier intersects the set of values of the first and second identifiers.

14. The method of claim 12, wherein the value of the third identifier intersects a set of values that is mutually exclusive from the set of values of the first and second identifiers.

15. The method of claim 1, wherein allocating the RBs is performed according to a non-contiguous frequency domain resource allocation, FDRA.

16. The method of claim 15, wherein the FDRA includes a first parameter to indicate a first starting RB of the received RB configuration within a first one of the two sets of at least one downlink RB or uplink RB.

17. The method of claim 15, wherein the FDRA further includes a frequency offset from the first starting RB to indicate a second starting RB of the received RB configuration within a second one of the two sets of at least one downlink RB or uplink RB.

18. The method of claim 15, wherein the FDRA further includes a single number of contiguous RBs that are allocated starting from the first starting RB or from both the first starting RB and the second starting RB.

19. The method of claim 15, wherein the FDRA further includes a first number of contiguous RBs that are allocated starting from the first starting RB and a second number of contiguous RBs that are allocated from the second starting RB.

20.-30. (canceled)

31. A wireless device, WD, configured to communicate with a network node using subband full duplex, SBFD, communications, the WD comprising:
a radio interface configured to receive from the network node a resource block, RB, configuration; and
processing circuitry in communication with the radio interface and configured to, for each symbol in a time slot allocate resource blocks, RBs, according to the received RB configuration, the received RB configuration including one of:
a first set of at least one uplink RB separating two sets of at least one downlink RB in the frequency domain, the two sets of at least one downlink RB being configured as a channel state information reference signal, CSI-RS, resource; and
a second set of at least one downlink RB separating two sets of at least one uplink RB, the two sets of at least one uplink RB being configured as a sounding reference signal, SRS, resource.

32.-78. (canceled)
